(19) United States
(12) Patent Application Publication
(10) Pub. No.: US 2012/0289103 A1
(43) Pub. Date: Nov. 15, 2012

(54) Unmanned Underwater Vehicle

(76) Inventors: Edison Thurman Hudson, Chapel Hill, NC (US); Stephen Carl Licht, Concord, MA (US); Donald Patrick Eickstedt, Nashua, NH (US)

(21) Appl. No.: 13/415,325

(22) Filed: Mar. 8, 2012

Related U.S. Application Data
(63) Continuation-in-part of application No. 12/890,584, filed on Sep. 24, 2010.
(60) Provisional application No. 61/497,013, filed on Jun. 14, 2011.

(51) Int. Cl. B63G 8/22; H02K 7/18; B63H 11/00

(52) U.S. Cl. 440/38; 114/331; 290/1 R

(57) ABSTRACT

An hybrid unmanned underwater vehicle comprises a body housing a controller; a vector thruster for propelling the body; deployable wings allowing the unmanned underwater vehicle to traverse by gliding as the unmanned underwater vehicle ascends and descends; a center-of-mass shifter for shifting a center-of-mass of the vehicle to allow the unmanned underwater vehicle to pitch up and pitch down; and one of a multi-stage buoyancy control system within the body and configured to adjust an apparent displacement of the unmanned underwater vehicle and an expandable outer shell configured to adjust an apparent displacement and therefore a buoyancy of the unmanned underwater vehicle.

### INTRODUCTION

This application is a continuation-in-part of U.S. patent application Ser. No. 12/890,584, filed Sep. 24, 2010, for an Autonomous Underwater Vehicle. This application claims priority to U.S. patent application Ser. No. 13/038,373, filed Mar. 1, 2011, for an Underwater Vehicle Buoyancy System. This application also claims priority to U.S. Provisional Patent Application No. 61/497,013, filed Jun. 14, 2011, for an Unmanned Underwater Glider. Each of these references is incorporated herein by reference in its entirety.

The present teachings relate to unmanned underwater vehicles. The present teachings relate more particularly to hybrid unmanned underwater vehicles that can perform a variety of behaviors that increase endurance and mission capability.

### BACKGROUND

A conventional unmanned underwater vehicle (“UUV,” also referred to herein as an autonomous underwater vehicle (“AUV”)), travels via powered propulsion and mostly travels in a horizontal direction. Depth is changed by changing thrust direction (e.g., via a control fin). A glider travels a vertical ascent and descent to move horizontally, using buoyancy to drive it vertically and therefore horizontally. Depth is changed by changing buoyancy. A hybrid vehicle has the advantages of long endurance by being able to use buoyancy to ascend, descend, and traverse horizontally, and additionally includes powered propulsion travel capability so that the vehicle has the advantages of both conventional and glider UUVs.

Current unmanned underwater vehicles (UUVs) are limited in operational scope by their inherent slow speeds of typically less than 5 knots, their endurance of typically about 8-10 hours, and their total mission range of less than 100 miles. Existing UUV's in current programs of record are large, heavy, require ship deployment near the area of operation, and frequently require specialized launch and recovery systems. Existing UUVs can also involve significant logistic tails (a large and perhaps customized launch assembly and process) to support deployment of the UUV. Small, lightweight UUVs exist, but are similarly hampered by limited energy storage, speed, and range. Some UUV's, such as gliders, use efficient buoyancy propulsion to traverse thousands of miles in a single deployment that may last up to 1 year, but they travel at speeds averaging ½ knot.

Current program of record (PoR) UUVs are large and heavy, requiring ship deployment near the area where the UUV will operate to minimize energy use during transit to the operation area, and to support specialized logistics or launch and recovery equipment needs. Small, lightweight UUVs exist but, as stated above, are hampered by limited energy storage, speed, and range. In addition, existing small UUVs are not air deployable. Some glider UUVs use efficient buoyancy propulsion to traverse up to thousands of miles in a single deployment that may last up to one year, but travel at speeds averaging about 0.5 knot. In addition, sonobuoys fill an important role in near real-time surveillance and oceanographic survey, but are unable to station keep or be redirected to new locations, and can drift away from a region of interest (ROI).

Regarding large displacement unmanned underwater vehicles (LDUUVs), existing LDUUVs have a mission endurance of about 10 hours. Environmental conditions can effect vehicle pitch and control plane deflection of an LDUUV in ways that, for example, decrease the LDUUV's efficiency. For example, for an LDUUV running at a nominal speed of 4 knots, in an out-of-trim state caused by a mere 2° C. water temperature change (the temperature change changing density of the water so that the LDUUV is no longer neutrally buoyant), the vehicle may need to operate with a 1.5° pitch angle offset and a mean stern plane deflection of 5° in order to maintain depth, which can reduce vehicle speed for the same propeller thrust by 7%. This can be estimated as a 14% increase in drag, assuming that vehicle drag scales with velocity squared. In the case of an LDUUV intended to be robust to temperature and salinity variations of 36° C. and 55 ppt, it is reasonable to expect that the LDUUV will experience much larger ballast and trim changes than the 1.5° pitch angle offset and 5° mean stern plane deflection noted above, thus implying a drag increase of much greater than 14%.

### SUMMARY

In accordance with various embodiments, the present teachings include an air launched UUV configured to perform as an unattended maritime sensor suite and as a compact autonomous vehicle that can be deployed from a variety of aircraft and watercraft (e.g., UAVs, USVs and UUVs). A UUV in accordance with the present teachings can be, for example, an “A” sized UUV that is air deployable using existing sonobuoy launch systems fitted to existing and future airframes or UAV's, allowing rapid, low logistic deployment to any operational location, providing a controllable surface or underwater sensor platform with, for example, a twenty-fold increase in endurance over existing “A” sized UUVs. A-sized, as used herein, includes a standard size and weight, defined by the Navy and other entities, that can be launched easily via a sonobuoy launcher (e.g., smaller than 4.88″ in diameter and weigh less than about 36 lbs).

The present teachings provide an A-sized unmanned underwater vehicle comprising: a body housing a controller; a vector thruster attached to the body, in communication with the controller, and configured to propel the body; at least one deployable wing structure attached to the body, in communication with the controller, and configured to be deployed to allow the unmanned underwater vehicle to traverse by gliding as the unmanned underwater vehicle ascends and descends; a center-of-mass shifter located within the body, in communication with the controller, and configured to shift a center-of-mass of the vehicle to allow the unmanned underwater vehicle to pitch up and pitch down; and one of a multi-stage buoyancy control system within the body and configured to adjust an apparent displacement of the unmanned underwater vehicle and an expandable outer shell configured to adjust an apparent displacement and therefore a buoyancy of the unmanned underwater vehicle.

The present teachings also provide a method for harvesting ambient underwater pressure for use in a remote vehicle having a pressure capture chamber and a capture and re-direct valve, the method comprising: allowing pressurized ocean water to flow through the capture and re-direct valve and drive fluid into the pressure capture vessel to pressurize the pressure capture vessel by filling the pressure capture vessel; and using pressure stored in the pressure capture vessel to drive a propulsion jet system.

The present teachings further provide a method for harvesting ambient underwater pressure for use in a remote vehicle having a pressure capture vessel and a capture and re-direct valve, the method comprising: allowing pressurized ocean water to flow through the capture and re-direct valve and drive fluid into the pressure capture vessel to pressurize the pressure capture vessel by filling the pressure capture vessel; and releasing pressurized fluid from the pressure capture vessel to push fluid through a power generator to convert stored pressurized fluid to electrical power.

The present teachings still further provide a method for harvesting ambient underwater pressure for use in a remote vehicle having a pressure capture chamber and a capture and re-direct valve, the method comprising: allowing pressurized ocean water to flow through the capture and re-direct valve and drive fluid into the pressure capture vessel to pressurize the pressure capture vessel by filling the pressure capture vessel; and using pressure stored in the pressure capture vessel to drive fluid from an internal reservoir of the autonomous underwater vehicle to an external bladder of the autonomous underwater vehicle to increase an apparent displacement and a buoyancy of the autonomous underwater vehicle.

The present also provide a system for harvesting ambient underwater pressure for use in a remote vehicle, the system comprising: a fluid reservoir; a pressure capture vessel connected to the fluid reservoir; and a capture and re-direct valve configured to allow pressurized ocean water to flow therethrough and drive a fluid from the fluid reservoir into the pressure capture vessel to pressurize the pressure capture vessel by filling the pressure capture vessel. Pressurized fluid can be released from the pressure capture vessel to perform work for the autonomous underwater vehicle.

The present teachings further provide an unmanned underwater vehicle that is propelled by buoyancy and achieves forward motion using wings for lift, the unmanned underwater vehicle having a size and form factor equivalent to a standardized sonobuoy and being configured for rapid air deployment and long endurance.

The present teaching still further provide a method for operating an unmanned underwater vehicle, the method comprising: increasing a relative buoyancy of an unmanned underwater vehicle under servo control and simultaneously shifting a center of mass of the unmanned underwater vehicle to cause at least a portion of the unmanned under water vehicle to rise above a water surface and remain above the water for a predetermined amount of time in a predetermined position using a minimal amount of stored energy; and while surfaced, performing tasks that can only be done on the surface, including one or more of RF communications, electro-optical image capture, air temperature measurements, wind measurements, determination of location using GPS or other celestial based location method.

The present teachings also provide a hybrid unmanned underwater vehicle comprising an onboard control computer, a buoyancy system, wings, and propulsion thrusters, the vehicle being able to optimize its expenditure of energy using available combined hybrid modes to minimize propulsion energy for tasks such as staying on the surface, gliding at slow speeds using negative and positive buoyancy changes and wings for lift, and efficiently utilizing traditional propulsion thrusters when needed.

The present teachings further provide an unmanned underwater vehicle configured to perform functions traditionally supported by sonobuoys and to change or hold its position using a propulsion system, the unmanned underwater vehicle comprising a closed-loop onboard controller configured to control the heading and speed of the propulsion system to move the vehicle to commanded or stored locations.

The present teachings still further provide an unmanned underwater vehicle comprising an expandable cylindrical body configured to change a buoyancy and a center of gravity of the vehicle, the expandable cylindrical body being capable of withstanding a predetermined range of external hydrodynamic pressures of surrounding water, and being capable of changing a center of gravity of the vehicle and a buoyancy of the vehicle to change a displaced volume of water or apparent internal density of the vehicle, thereby controlling buoyancy and center of gravity of the vehicle.

The present teachings also provide a hybrid unmanned underwater vehicle comprising an expandable body with a propulsion section, wherein portion of the expandable body, can be compressed to decrease the vehicle's external displacement volume, and can be expanded from the body to increase the vehicle's external displacement.

The present teachings further provide a method for facilitating communications between an unmanned underwater vehicle and a remote control site, the method comprising expanding a body of the vehicle to establish and maintain positive buoyancy for the vehicle; shifting a center of mass of the vehicle so that a nose or a tail of a cylindrical body of the vehicle is held above a surface of the water without the addition of electro-motive force; and remaining in the shifted and positively buoyant position of the vehicle so that radio communications, above-the-water electro-optics, and other subsystems needing to be above the surface to operate efficiently, can perform tasks.

The present teachings still further provide a large displacement unmanned underwater vehicle including one or more sensors, a propulsion system, and a controller for controlling a mission of the vehicle, and comprising: a variable buoyancy system including a first variable buoyancy engine located toward a bow of the vehicle and a second variable buoyancy engine located toward a stern of the vehicle, the variable buoyancy system being configured to control apparent displacement of the vehicle to actively control vehicle buoyancy to maintain neutral buoyancy and reduce ballast and trim errors to reduce propulsion power requirements.

Additional objects and advantages of the present teachings will be set forth in part in the description which follows, and in part will be obvious from the description, or may be learned by practice of the present teachings. The objects and advantages of the present teachings will be realized and attained by means of the elements and combinations particularly pointed out in the appended claims.

It is to be understood that both the foregoing general description and the following detailed description are exemplary and explanatory only and are not restrictive of the present teachings, as claimed.

The accompanying drawings, which are incorporated in and constitute a part of this specification, illustrate several embodiments of the present teachings and together with the description, serve to explain the principles of the present teachings.

### BRIEF DESCRIPTION OF THE DRAWINGS

FIG. 1 is a schematic diagram illustrating an exemplary embodiment of a hydraulic multi-stage buoyancy system in accordance with the present teachings.

FIG. 2 is a schematic diagram illustrating another exemplary embodiment of a multi-stage buoyancy system in accordance with the present teachings.

FIG. 3 is a schematic diagram of an exemplary embodiment of a pressure capture vessel system in accordance with various embodiments of the present teachings.

FIG. 4A is a schematic diagram of an exemplary embodiment of a pressure capture vessel in accordance with various embodiments of the present teachings.

FIG. 4B is a schematic diagram of an exemplary embodiment of a pressure capture vessel in accordance with various embodiments of the present teachings.

FIG. 4C illustrates an embodiment of the present teachings wherein captured pressure is used to propel an autonomous underwater vehicle.

FIGS. 5A and 5B illustrate a portion of an exemplary embodiment of an of an outer shell/body of an unmanned underwater vehicle (UUV) wherein an accordion-like portion can expand and contract to change the displacement of the UUV body and thus its buoyancy.

FIG. 6 illustrates an exemplary embodiment of a mechanism for length expansion and contraction of the UUV shell/body, with the shell/body in a contracted state.

FIG. 7 illustrates the mechanism embodiment of FIG. 2, with the shell/body in an expanded state.

FIG. 8 illustrates another exemplary embodiment of a mechanism for buoyancy and center of mass change of the UUV shell/body.

FIG. 9 schematically illustrates a UUV surfaced in a position to exchange data with a remote control site.

FIG. 10A is a perspective view of an embodiment of a UUV having wings that can be stowed and deployed, with the wings in a stowed position.

FIG. 10B is a perspective view of the embodiment of FIG. 6A, with the wings in a deployed position.

FIG. 11 is a perspective view of an embodiment of a UUV in an ascent attitude, the illustrated UUV being air deployable.

FIG. 12 illustrates a basic principle of hydraulics that can be utilized in a UUV in accordance with the present teachings.

FIG. 13A illustrates a side view of an embodiment of a UUV having deployed wings and with an accordion-like body portion in a contracted position.

FIG. 13B illustrates a side view of an embodiment of a UUV having an antenna at its nose and an accordion-like body portion in a contracted position.

FIG. 13C illustrates a side view of an embodiment of a UUV having deployed wings and with an accordion-like body portion in an expanded position.

FIGS. 14A-C provide schematic diagrams of an underwater vehicle attempting to maintain level flight at three speeds while positively buoyant.

FIGS. 15A and 15B illustrate an exemplary variable buoyancy engine with an external bladder that is deflated and inflated, respectively.

FIG. 16 illustrates an exemplary embodiment of a variable displacement mechanism.

FIGS. 17A-C illustrated an exemplary embodiment of a bellows assembly for use in a variable buoyancy engine.

FIG. 18 is a control block diagram of an exemplary time-averaged feedback control algorithm to be used for ballast and trim control in accordance with certain embodiments of the present teachings.

FIG. 19 is a control block diagram of an exemplary time-averaged feedback control algorithm, augmented with a model-based feed forward control algorithm that takes advantage of environmental data to reduce latency.

FIG. 20 is a control block diagram of an exemplary adaptive model-based ballast and trim controller.

FIG. 21 illustrates an iRobot® Seaglider with a stern-mounted variable buoyancy engine.

FIG. 22 illustrates an exemplary embodiment of a LDUUV employing two variable buoyancy engines.

### DESCRIPTION OF EXEMPLARY EMBODIMENTS

### Air-Deployable UUV Platform for Sensors

Reference will now be made in detail to the present teachings, exemplary embodiments of which are illustrated in the accompanying drawings. Embodiments of a UUV in accordance with the present teachings can employ methods proven in ocean gliders coupled to small form factor UUV's to provide a system with exceptional duration and mission flexibility. Embodiments of the present teachings that include a substantially “A” sized design will be air deployable using existing sonobuoy launch systems fitted to existing and future airframes or unmanned air systems, allowing rapid, low logistic deployment to various operational locations. Embodiments of the present teachings provide a method to convert the buoyancy and distribution of mass status of a UUV from a status that is efficient at low energy loitering and station keeping to a status that can be propelled either at low speeds for tactical insertion, or at high speeds for pursuit of contacts or repositioning.

An UUV in accordance with the present teachings can be utilized to enable deployment of persistent sensors on demand that communicate their data frequently with, for example, a base station. This capability can be utilized, for example, in programs including LBS-SFI, agencies such as NOAA, and in many oceanographic programs needing rapid deployment of in situ sensors with multi-day duration to capture arising natural and/or man-made events.

In certain embodiments of the present teachings, utilizing a vectored thruster propulsion such as that employed in the iRobot® Ranger™, a vehicle can include hybrid capabilities. Hybrid capabilities can include, for example, the ability to act as a glider to conserve energy, travel horizontally via powered propulsion, loiter, and/or station keep. Certain embodiments of the present teachings also include various sensor configurations making the UUV capable of performing many missions including, but not limited to: (1) environmental surveying; (2) core tasks in anti-submarine warfare (ASW) missions; core tasks in mine countermeasure missions (MCMs), and core tasks in intelligence, surveillance and reconnaissance (ISR) missions. Multiple UUVs in accordance with the present teachings can provide mobile, re-directable assets that can be configured to listen, classify, track, and report on acoustic events, for example persistently listening and localizing as a network, with the capacity to sprint and track targets for short intervals.

The present teachings provide a method to convert the buoyancy and distribution of mass of a UUV from one that is efficient at low energy loitering and station keeping to one that can be propelled either at low speeds for tactical insertion, or at high speeds for pursuit of contacts or repositioning, thus increasing the overall mission capabilities of a single UUV. By cross pollinating design principles used in existing ocean glider designs with a vectored thruster propulsion based UUV design, a UUV in accordance with the present teachings can produce a vehicle with these hybrid capabilities. Depending on sensor configuration, a UUV in accordance with the certain embodiments of the present teachings can accomplish many missions ranging from environmental survey, to core tasks in ASW, MCM, and ISR missions. As an ASW tool, a swarm of UUV in accordance with the present teachings can be configured to provide a unique solution to ‘hold-at-risk’ CONOPS, providing mobile, re-directed assets to listen, classify, track, and report on acoustic events, persistently listening and localizing as a network, with the capacity to sprint and track targets for short intervals.

Integrated with high speed digital communications, a UUV in accordance with the present teachings can provide a valuable maritime complement to UAVs ranging, for example, from hand-launched PUMA-AV to ship-based Scan Eagle UAS, FireScout MQ8 VTUAV, and BAMS MQ-4 UAS. Unlike conventional AUV programs that require return to ship for data recovery, an UUV in accordance with the present teachings can deliver situational awareness in near real-time, by being rapidly deployed by air, providing enhanced capabilities for data collection, surfacing in a desired manner while minimizing energy used during such surfacing, and using a UAS-based digital communication link to deliver data beyond line-of-sight limits.

In certain embodiments, a UUV in accordance with the present teachings can be integrated with high speed digital communications and, unlike conventional UUV programs that require return-to-ship for data recovery, such embodiments are capable of delivering situational awareness in near real-time by being rapidly deployable by air and by using a digital communication link to deliver data beyond line of sight limits.

With a UUV in accordance with certain embodiments of the present teachings, a range of performance and endurance is possible, the performance and endurance being dependent on, for example, the mission profile and sensor utilization. Increased endurance can be accomplished, for example, with passive sensors sampling at a predetermined rate. Endurance will be decreased, for example, by high performance “sprint to target” actions, which are desirable in certain missions and can be invoked by events or commands.

An exemplary embodiment of a UUV in accordance with the present teachings can include an A-sized body of, for example, less than about 4.8″ in diameter and about 36″ in length, which weighs less than about, for example 40 lbs. Exemplary system performance characteristics can include, for example: (1) sonobuoy launcher compatibility and air worthiness (for example, an LAU-126 or NATO equivalent); (2) surface loitering with positive buoyancy, and exposing an antenna in a “spar buoy” mode; (3) station keeping in currents of up to 4 knots within a 100 meter radius using GPS position and active propulsion; (4) underwater horizontal traverse with neutral buoyancy from the surface to about 200 meters deep; (5) powered propulsion using a vectored thruster at speeds ranging from about 1 knot to about 10 knots; (6) buoyancy driven transit with a glider dive profile at about 0.25 knot to about 1.0 knot.

An exemplary embodiment of a UUV in accordance with the present teachings can have an endurance of, for example, up to about 7 days using a combination of operational modes while passively sensing, can loiter in low power mode for up to about 14 days, or can scuttle on command or at a set time.

In accordance with certain embodiments, the UUV can have sensors, for example a sensor payload, that supports acoustic recording, classification, and detection from sensors including, for example, one or more of hydrophones, a laser gradiometer (magnetics), an acoustic modem, an acoustic projector, a dual frequency “blazed array” imaging SONAR, a conductivity, temperature, and depth (CTD) sensor, a pressure sensor, an O₂ saturation sensor, an optical backscatter sensor, a fluorometer, an ADCP current profiler, a turbulence sensor, a surface/underwater electro-optical camera, and lighting.

In certain embodiments of the present teachings, UUV communications can be accomplished via a radio frequency (RF) link for digital communications including, for example, one or more of device description language (DDL), Iridium, and Fleet SatCom (UHF). In various embodiments, the system power can comprise, for example, an onboard Lithium primary power source for long endurance missions, or a Lithium Ion (LION) rechargeable power source for training modes.

A UUV in accordance with the present teachings comprises an A-sized on-demand air-droppable device that can be utilized to decrease the time to deploy the device for missions in any region of interest (ROI), and greatly increases its persistence by eliminating energy expended during transit to/from the ROI. Embodiments of the UUV can utilize, for example, an energy efficient hybrid propulsion system for transit and station keeping, to achieve additional mission endurance. Mobility can enable the UUV to take advantage of its increased endurance by actively remaining in the ROI while also retaining sprint speeds of up to 8 knots.

Certain embodiments of a UUV in accordance with the present teachings can employ on-board sensors such as, for example, an on-board sensor suite enabling the UUV to enhance its mission capabilities beyond known missions such as anti-submarine warfare (ASW) missions. In addition, embodiments of the present teachings having acoustic underwater communications capabilities can exchange information with other UUVs, ships, and submarines, enabling capabilities including collaborative “track and trail” against detected targets. When used as a replacement for standard sonobuoys, embodiments of a UUV in accordance with the present teachings can deliver significant cost savings for missions greater than eight hours in addition to increased capability. Used as an intelligence, surveillance, and reconnaissance (ISR) platform with appropriate sensors, a UUV in accordance with the present teachings can facilitate covert and persistent sensor access to denied areas. Data reach-back can be employed and combined with an ability of the UUV to persist, thereby offering an alternative means to achieve unmanned system objectives for overt and covert intelligence, surveillance and reconnaissance (ISR) and anti-submarine warfare (ASW) missions in contested or denied areas.

As an anti-submarine warfare (ASW) mission tool, a UUV in accordance with the present teachings can be configured to replace standard sonobuoys for missions longer than, for example, eight hours. In additional or alternatively, a line of air-dropped UUVs can be configured to form an underwater acoustic or magnetic trip wire arrangement with each vehicle having a range of, for example, about 2 kilometers and the vehicles being stringed in a line (or curve or other designated shape) such that a line of listening is created by sequentially-located strung-together listening UUVs. Further, in a hold at risk anti-submarine warfare (ASW) mission CONOPS scenario, a UUV in accordance with the present teachings can be utilized as mobile, re-deployable assets to detect, localize, classify, track, and report on acoustic and magnetic anomalies. Hold-at-risk includes forming a trip wire around, for example an exit of a river, bay, or harbor using, for example, a listening trip wire arrangement. Any vehicle exiting the river, bay, or harbor can be considered a risk. Sonobuoys currently used for hold-at-risk tasks can drift away and typically must be re-seeded continuously. In various embodiments of the present teachings using onboard automated target recognition (ATR), detected events can be relayed, for example via a radio frequency (RF) link, when the UUV surfaces. Thereafter, the present teachings contemplate that the UUV can be directed by an operator to sprint toward a target and/or track the target. In certain exemplary embodiments, the UUV can be configured to autonomously and collaboratively track and trail suspected targets, providing remote operators with current and refined target state estimates (e.g., target speed, course, etc.). To track and trail, for example, one or more of the hybrid UUVs used in a hold-at-risk task can detect and follow a target that exits a body of water. As an intelligence, surveillance and reconnaissance (ISR) mission tool, a UUV in accordance with the present teachings can be covertly inserted into denied areas from large stand-off distances to provide, for example, persistent monitoring using a variety of acoustic, magnetic, e-field, optical, and RF sensors.

A multi-stage buoyancy system can be employed in a UUV of the present teachings. Various embodiments provide a system for changing the apparent displacement or incorporated mass of an autonomous underwater vehicle in an effort to achieve neutral buoyancy, ascend (achieve positive buoyancy), or descend (achieve negative buoyancy), by displacing fluid within an underwater vehicle comprising two or more displacement mechanism stages or subsystems as set forth hereinbelow, and a control system that determines an appropriate stage to utilize in the underwater vehicle's ambient environment at any given segment of the underwater vehicle's dive profile. Underwater vehicles (e.g., gliders and hybrids in accordance with the present teachings) can utilize fins that cause the underwater vehicle to move laterally as it ascends and descends. Thus, buoyancy changes can be used to assist the underwater vehicle in moving forward along a desired path.

In many existing glider UUVs, most (e.g., about 75%) of the underwater vehicle's energy is used to pump fluid (e.g., hydraulic fluid, water, seawater, or other non-compressible fluids or fluids having low compressibility) into an external bladder from an internal storage reservoir to increase the underwater vehicle's apparent displacement and buoyancy to cause the underwater vehicle to ascend to move forward and/or to reach the surface of the water for data receipt and transmission. The amount of pressure required to pump fluid into the external bladder typically varies by depth. For example, in shallow water (e.g., less than about 200 meters) the required pressure can have a magnitude of hundreds of psi, whereas in deep water (e.g., about 200 meters to about 1000 meters) the required pressure can have a magnitude of thousands of psi. A multi-stage buoyancy system can facilitate efficient pumping at a variety of depths, by using more energy-efficient low pressure pumps at lesser depths and alternatively or additionally using a high pressure pump at greater depths to provide the needed pump pressure only when necessary. In another embodiment, a pump motor can be employed with a continuously variable transmission (CVT) that can adapt to a torque-speed curve resulting in an optimal pressure/pumping rate needed at any given depth of the underwater vehicle. The vehicle depth can be determined, for example, by sensing the ambient pressure.

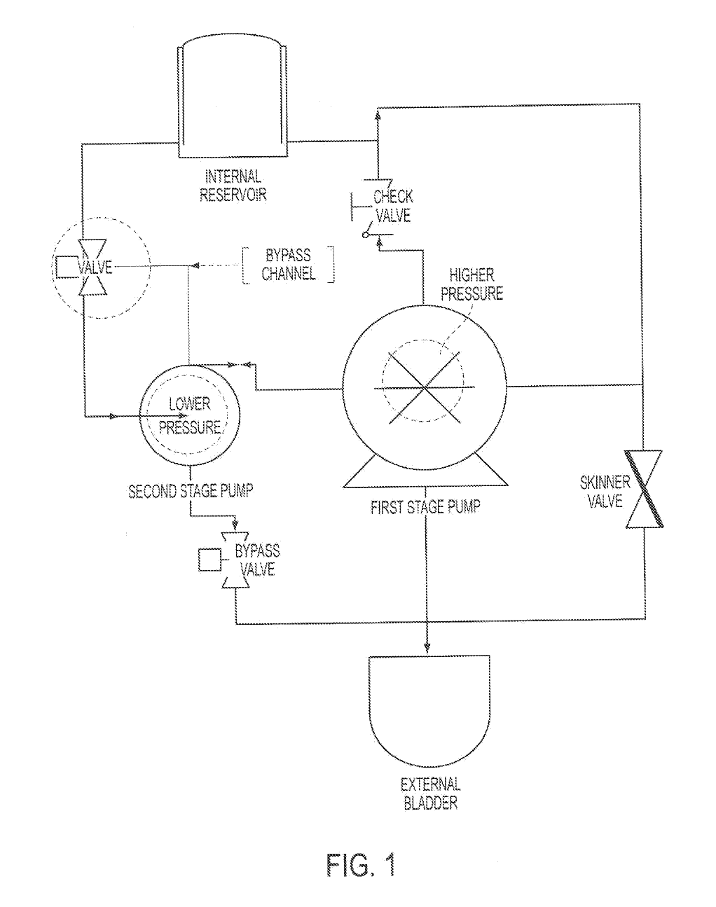

FIG. 1 is a schematic diagram illustrating an exemplary embodiment of a hydraulic multi-stage buoyancy system in accordance with the present teachings. The exemplary embodiment of FIG. 1 includes, among other elements: a first stage (Stage 1) pump for high pressure depths; a second stage (Stage 2) pump for lower pressure depths; an internal reservoir for fluid (e.g., hydraulic fluid) used to change buoyancy; and a buoyancy chamber or external bladder mounted on an external surface of the underwater vehicle that changes in size and displacement when hydraulic fluid is pumped into it or expressed from it by ambient pressure as the underwater vehicle enters deeper water. The external bladder is preferably at least somewhat elastic.

FIG. 1 also illustrates an exemplary embodiment of paths fluid can take between the internal reservoir and the external bladder. In the illustrated embodiment, three paths exist between the accumulator/reservoir and the external buoyancy chamber or bladder, two of which contain a fluid displacement mechanism. One path runs fluid through a low pressure “Second Stage” (Stage 2) pump and through a check valve such as the illustrated bypass (check) valve that prevents movement of fluid in an unwanted direction. Another path runs fluid through a bypass (check) valve and through a high pressure “First Stage” (Stage 1) pump. The parallel channels having bypass check valves can combine to eliminate unproductive loads on a stage that is currently operating, by providing a direct path to the internal reservoir, without the fluid needing to be pushed or pulled through any non-operating elements (e.g., non-operating stages). The third path allows fluid to return from the external bladder to the internal reservoir through a valve such as, for example, a solenoid valve (e.g., a Skinner valve).

To cause a decrease the underwater vehicle's buoyancy, the Skinner valve can be opened between the external bladder and the internal reservoir, allowing fluid to be driven by ambient pressure from the external bladder to the internal reservoir. In the illustrated embodiment of FIG. 1, a return valve such as an electronically actuated solenoid valve (e.g., a Skinner valve) is located between the external bladder and the internal reservoir, although those skilled in the art will appreciate that other suitable types of valves can alternatively or additionally be used. The valve between the external chamber and the internal reservoir should remain selectively closed while the external buoyancy chamber is being filled to increase the underwater vehicle's buoyancy.

In the illustrated embodiment, a check valve is provided between the line returning fluid from the external bladder to the internal reservoir and the Stage 1 pump. This check valve can prevent fluid returning to the internal reservoir from being diverted to the Stage 1 pump.

While atmospheric pressure can be sufficient to drive fluid from the external bladder to the internal reservoir, certain embodiments of the present teachings also contemplate using one or more of pumps to drive fluid from the external bladder to the internal reservoir, for example if fluid is not moving therebetween or if fluid is not moving fast enough therebetween to achieve a desired rate of buoyancy change.

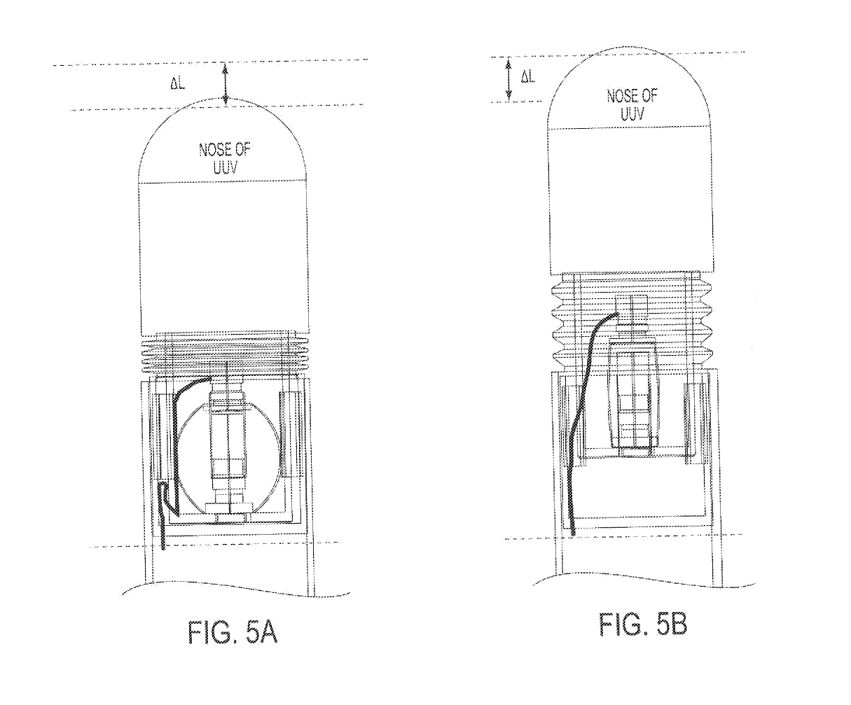

The illustrated exemplary embodiments of the present teachings eliminate the impact of serial placement of stages by placing the stages in parallel. Serial placement of the stages can impede an optimal performance of stages downstream or upstream in the system. If, for example, a smaller pump was positioned between a larger pump and the reservoir, the smaller pump could restrict the larger pump's access to the reservoir, making it less efficient and/or slower for the larger pump to move fluid from the reservoir to the external bladder. Pumps arranged in series between the reservoir and the bladder, rather than in parallel as illustrated in FIG. 5, would tend to add frictional and orifice (size) restrictions that can impede fluid flow.

Certain embodiments of the present teachings can combine two or more stages to achieve either greater total pressure output to overcome pressures at deeper depths or to increase the rate of change of buoyancy by pumping more fluid into the bladder to increase buoyancy. Certain embodiments of a control system for an embodiment utilizing two stages to increase a rate of change in buoyancy can, for example, sense the rate at which buoyancy of the underwater vehicle is being changed, which in some embodiments can be determined by the displacement of an internal plate inside the fluid reservoir, and in other embodiments by, for example, measuring a rate of change of reservoir pressure. When the rate of buoyancy change reaches or exceeds a desired level, one or both of the stages can be halted as needed to save energy. The stage to be halted can depend, for example, on the underwater vehicle's depth. For example, if the underwater vehicle is in deeper water requiring use of a stage 1 pump, the stage 2 pump would be halted. Otherwise, if the underwater vehicle is in shallower water requiring use of a stage 2 pump, the stage 1 pump would be halted. If less than all of the stages of the system are being utilized and the rate of buoyancy change falls below a desired level, one or more additional stages can be switched on to provide additional buoyancy fluid flow.

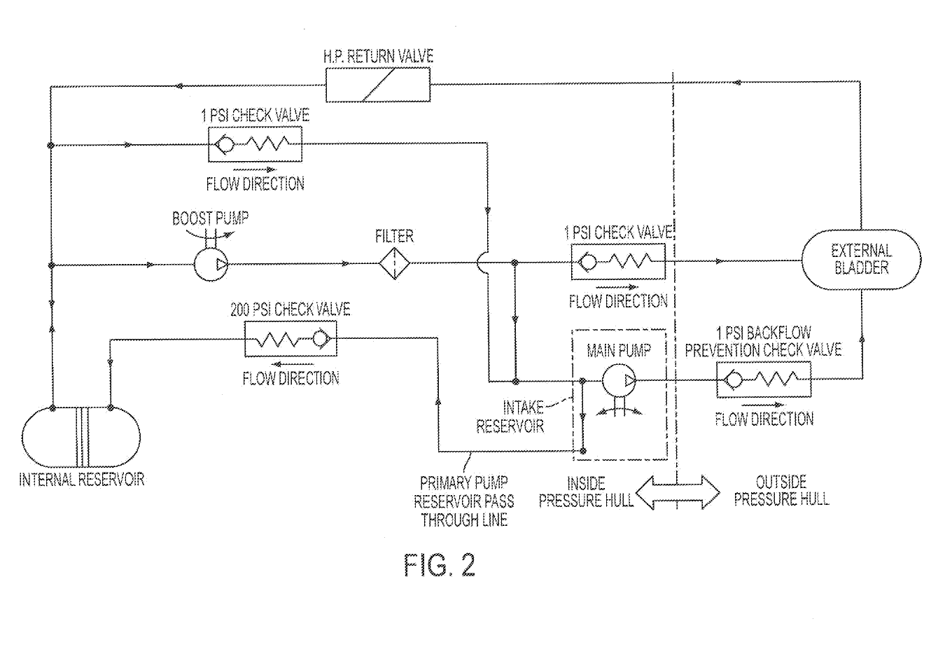

FIG. 2 is a schematic diagram illustrating another exemplary embodiment of a multi-stage buoyancy system in accordance with the present teachings. The exemplary embodiment comprises a main pump and a boost pump for pumping fluid from an internal reservoir to an external bladder. The main pump can comprise, for example, a high pressure pump. The boost pump can comprise, for example, a lower pressure pump. As shown, fluid can travel from the internal reservoir to the external bladder to increase buoyancy via a first path and/or a second path. The first path includes the boost pump, a filter, and a check valve, the check valve ensuring that fluid flows through this path only in the desired direction. A filter is not essential, but can protect the system from contaminants in the fluid that would decrease the flow or clog the valves. The second path comprises the main pump with a check valve on either side thereof, each check valve ensuring that fluid flows through the second path only in a desired direction.

When an underwater vehicle is diving, movement from the external bladder to the internal reservoir is called ‘bleeding’ and the ambient underwater pressure can be used to push fluid from the external bladder into the underwater vehicle's internal reservoir by pressing on the external bladder. In addition, in accordance with certain embodiments, the underwater vehicle can have a negative internal pressure that assists the bleeding process and encourages fluid flow back to the internal reservoir when a high pressure (h.p.) return valve between the external bladder and the internal reservoir is opened.

In certain embodiments, the check valve in the second path, located outside the pressure hull, can be located within the external bladder and can prevent fluid from flowing back into the pump(s). Because the external bladder is both elastic and exposed to the ambient pressure of the surrounding water, it will experience an internal pressure that tends to push fluid back toward the pump(s). The check valve located outside the hull (e.g., inside the external bladder) serves as a backflow preventer, making the return valve the only outlet from the external bladder. The return valve is selectively openable and only opened when it is desirable to allow fluid to bleed from the external bladder.

In certain embodiments of the present teachings, a flow-through connection can exist through an intake reservoir of the main pump. Pressure from the boost pump can flow to the external bladder until a predetermined ambient pressure of, for example, 200 psi exists. When the predetermined ambient pressure is reached, fluid from the boost pump can be sent (circuitously but effectively) through the main pump's intake reservoir via a flow-through connection and back to the internal reservoir. The flow-through connection thus can function as a safety path to return unnedded fluid to the internal reservoir.

A path exists for fluid to flow from the external bladder to the internal bladder to decrease the underwater vehicle's apparent displacement and therefore its buoyancy, the path including a return valve such as an electronically actuated solenoid valve (e.g., a Skinner valve) as shown in the embodiment of FIG. 1.

In accordance with certain embodiments, the underwater vehicle can comprise a variable buoyancy displacement chamber or variable volume enclosure that can be offset from the center of gravity of the underwater vehicle, providing a means to change the displacement volume or the mass of the underwater vehicle relative to its center of gravity, for example to tip the nose of the underwater vehicle up or down. For example, such a mass distribution mechanism can comprises a vehicle battery or another defined mass within the underwater vehicle whose location within the underwater vehicle can be adjusted to tip the nose of the underwater vehicle up or down, or to roll the underwater vehicle to its left or right. Movement of the mass distribution mechanism can be controlled by a control system of the underwater vehicle, allowing the control system to steer the underwater vehicle as needed to cause the underwater vehicle to descend to desired depths, ascend to the water surface, roll/steer left or right, or keep station as might be determined by the buoyancy of the underwater vehicle relative to the surrounding ambient water and the center of buoyancy of the underwater vehicle.

Various embodiments of the present teachings provide an arrangement of multiple stages such that they can be combined to provide a higher rate of buoyancy change or higher torque, whereby a bypass system allows the stages to be provided in parallel. Various embodiments can also comprise a mechanism to change the center of gravity of the autonomous underwater vehicle to cause the underwater vehicle to roll (rotation about the longitudinal axis of the vehicle) and pitch (rotation about the lateral axis of the vehicle), such that the attitude of the vehicle can be changed to provide a desired glide angle relative to forward motion. The external bladders can alternatively or additionally be used to cause the underwater vehicle to roll and pitch, and can also be used to change the center of gravity of the autonomous underwater vehicle.

The multi-stage buoyancy system can comprise as many stages as are deemed necessary and expedient to produce the best trade-off between energy use for pumping and (a) the mass of parts needed for each stage, (b) the volume occupied by each stage within the pressure hull, and (c) the complexity of controls and plumbing. Different stages can comprise different components. Exemplary fluid displacement systems that can be used in accordance with the present teaching include, for example, a piston-driven pump, a systolic pump, a Stirling engine, and/or other suitable devices that can move fluid.

A multi-stage buoyancy system can be implemented using a variety of approaches that embody the principle of a depth/pressure dependent selection of the most efficient pump stage. By using a pressure sensor that detects the surrounding water pressure at a given depth, and a volume sensor that detects the vehicle's displacement volume, a control system of the vehicle can enable a pumping stage that is energy efficient for the detected environmental pressure if a change in apparent displacement is needed. In principle, a system of many (“N”) stages can be employed, wherein two is the simplest case and may be adequate for many underwater vehicles.

Although the pump stages are preferably arranged in parallel, a connection can exist from the output of one pump stage to the intake of another pump stage. This series-like plumbing can function, for example, as a safety path for any pump stage that needs priming.

One or more known energy storage systems onboard the autonomous underwater vehicle can power the fluid displacement mechanisms, the sensors, and the control system. In certain embodiments, the energy storage systems can comprise one or more batteries, such as rechargeable (e.g., lithium) batteries.

As set forth above, various embodiments of the present teachings comprise a control system for an autonomous underwater vehicle, the control system comprising a control computer, sensors to determine depth, heading angles, and rate of buoyancy change, and a buoyancy system for changing the apparent displacement or mass of the underwater vehicle using fluid displacement mechanisms to move fluid between an internal reservoir and an external bladder.

Certain embodiments of the present teachings provide an algorithm for determining the appropriate fluid displacement mechanism to achieve a desired change in buoyancy at a specific range of depths. A hydraulic system configured with multiple fluid displacement mechanisms in the form of pumping stages or alternate gearing ratios that can efficiently transfer work from one stage to another stage without significant impairment of a selected stage, and can work in concert or separately to produce changes in buoyancy with respect to the ambient pressure in effect at the time of execution of buoyancy change.

The present teachings provide a configuration of controls, sensors, and fluid displacement mechanisms that can include motors, pistons, or similar mechanisms that enable a change of buoyancy of the autonomous underwater vehicle in accordance with its environment, to minimize its expenditure of stored energy. An advanced method uses a continuously variable transmission to effectively obtain the benefits of a large number of physically separate stages by employing a single stage having continuously changeable torque, flow rate, and pressure outputs.

Pressure Capture and Harvesting

Certain embodiments of the present teachings contemplate a deep water pressure capture system that can convert deep water ambient pressure to useful energy in deep diving autonomous underwater vehicles, for example vehicles that dive to depth of anywhere from 1000 meters to 6000 meters. At such depths, ambient pressures of thousands of psi are experienced. For example, an ambient pressure of 1400 psi is typical at about 1000 meters of ocean depth. Energy from deep water ambient pressure can be harvested regardless of water temperature, making such harvesting reliable and possible in all deep water dives.

In an exemplary implementation, a valve to the pressure capture vessel can be opened at the surface and remain open until an apogee stage is reached (i.e., until about when the vehicle reaches the bottom or a maximum dive depth). The valve for to the pressure capture vessel can then be closed and the harvested pressure can be used as needed as or when the vehicle surfaces.

Using a pressure capture vessel that can safely receive and store pressurized fluid of 1400 psi or greater, the energy content of the differential pressure (i.e., the difference between surface ambient pressure and ambient pressure at greater depths) can be captured. The present teachings contemplate a number of uses for captured pressure. For example, captured pressure can be used to power controlled jets that can propel and direct the autonomous underwater vehicle, and/or can be used to drive a pressure-driven mechanism, as described below in more detail. In addition or alternatively, electrical power can be generated from captured pressure, for example upon nearing the surface and as described below in more detail, and can be used for functions such as communications and computing. In accordance with certain underwater vehicle embodiments utilizing rechargeable batteries, captured energy can be converted to electrical power and used to recharge the batteries.

As stated above, data transmission and receipt upon surfacing can use about 10 Watts of energy. The present teachings contemplate using the stored pressure to generate about 2 Watts of energy. While the pressure capture vessel can add weight to, and possibly increase the size of, the autonomous underwater vehicle, thus increasing the vehicle's energy usage, the present teachings contemplate selecting a container type that allows harvesting of more energy than it requires.

Stored pressure can be used, for example, upon surfacing for data transmission and receipt, or to drive fluid from the internal reservoir to the external bladder as the autonomous underwater vehicle approaches the surface and surfaces. Pressures stored at depth (e.g., 1400 psi) can easily be used to drive fluid into the external bladder when in shallower waters having an ambient pressure of about, for example, 50 psi. To ascend or when ascending, harvested pressure can be used in the place of one or more pumps to drive fluid from the internal reservoir to the external bladder.

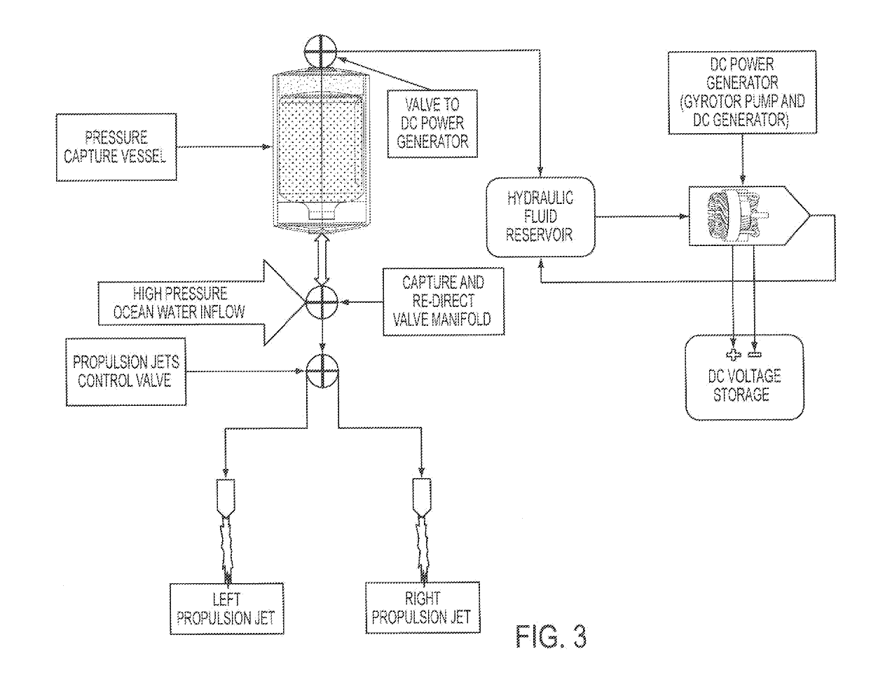

FIG. 3 is a schematic diagram of an exemplary embodiment of a pressure capture vessel system for use in a UUV in accordance with various embodiments of the present teachings. The pressure capture vessel can be utilized to capture useful energy at greater depths during underwater vehicle operations. Underwater vehicles diving to depths of, for example, thousands of meters, experience ambient pressures of more than about 1400 psi. The present teachings contemplate using a pressure capture vessel to capture pressure when at depth, safely contain such pressure, and hold it for use, for example, at shallower depths or on the surface, where the full energy content of the differential pressure can be captured. Several methods of using the captured pressure can be applied, including: (1) directly using the pressure to form controlled jets to propel the underwater vehicle; and/or (2) using a pressure driven mechanism to generate electrical power using the differential pressure, wherein the electrical power can be used, for example, for functions such as communications or computing.

In accordance with certain embodiments of the present teachings, a valve allowing access to the pressure capture vessel can be opened when the underwater vehicle is in shallow water and kept open as the vehicle reaches greater depths. The access valve for the pressure capture vessel can be closed, for example, when the vehicle has reached a certain desirable depth, when the vehicle has reached its maximum depth, or when the pressure capture vessel has reached a predetermined pressure level. The access valve can remain closed until the underwater vehicle is ready to harvest the pressure therein. The present teachings contemplate the pressure content or energy potential of the pressure capture vessel can all be used at once or can be used intermittently, with the access valve opening and closing as needed.

Referring to FIG. 3, the illustrated pressure capture vessel system comprises a pressure accumulator vessel, a left propulsion jet, and a right propulsion jet. A propulsion jet control valve and a capture and re-direct valve manifold (e.g., an access valve that can be used to capture and re-direct pressure) are provided between the pressure accumulator vessel and the left and right propulsion jets. The present teachings contemplate using any number of propulsion jets to drive power and/or steer the underwater vehicle. For example, a single propulsion jet can be utilized to drive the underwater vehicle forward, and a single directable propulsion jet can be utilized to drive the underwater vehicle forward and to steer the underwater vehicle.

The pressure capture vessel can be pressurized by an inflow of ocean water when a capture and re-direct valve manifold is open to allow pressurized ocean water to flow therethrough and drive fluid into the pressure capture vessel. In certain embodiments of the present teachings, the fluid can pressurize the pressure capture vessel by filling the pressure capture vessel. The fluid that fills the pressure capture vessel can comprise, for example, a hydraulic fluid.

The pressure capture vessel can be connected via control valves to a power generator and a propulsion jet system. In use, pressure stored in the pressure capture vessel can be used to drive the propulsion jet system and/or the power generator. The illustrated propulsion jet system comprises a left propulsion jet and a right propulsion jet. The propulsion jets can be used to steer the autonomous underwater vehicle or to provide a speed boost. A speed boost can be useful, for example, when large currents are encountered and must be countered by an increased underwater vehicle speed. Steering can allow an operator to drive the autonomous underwater vehicle and can allow the underwater vehicle to track targets and follow complex mission plans.

To convert stored pressure to electrical power, the stored pressure can be released from the pressure capture vessel and used to push hydraulic fluid from a hydraulic fluid reservoir through a power generator (e.g., the illustrated gyrator pump and DC power generator). The electrical power produced by the generator can be used immediately by the autonomous underwater vehicle, can be stored in a voltage storage device (e.g., a rechargeable battery), or both.

The power generator shown in FIG. 3 can comprise, for example, a DC power generator such as a gyrator pump and DC generator. A voltage storage component, such as the disclosed DC voltage storage component, can be provided to store generated energy that is not immediately used. The pressure captured in a first chamber of the pressure accumulator vessel presses a fluid (e.g., a hydraulic fluid) in another chamber of the pressure capture vessel into a hydraulic fluid reservoir that is located between the pressure accumulator vessel and the power generator.

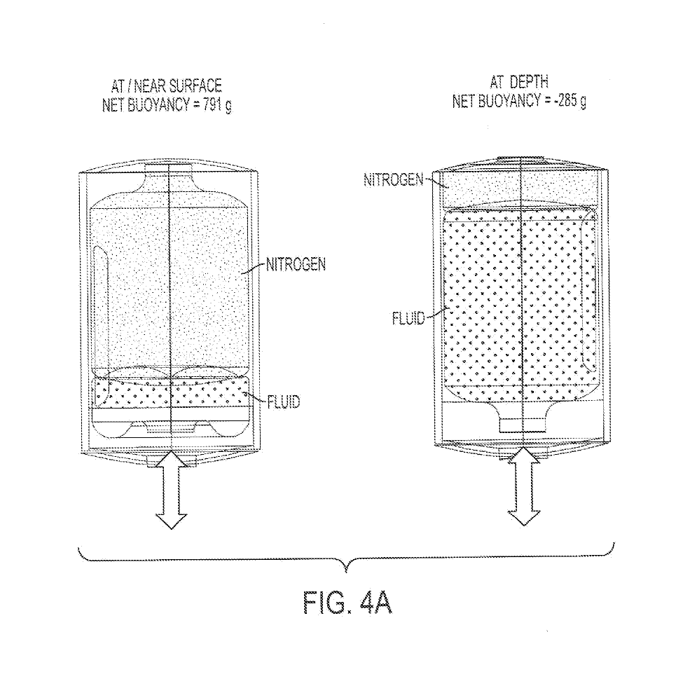

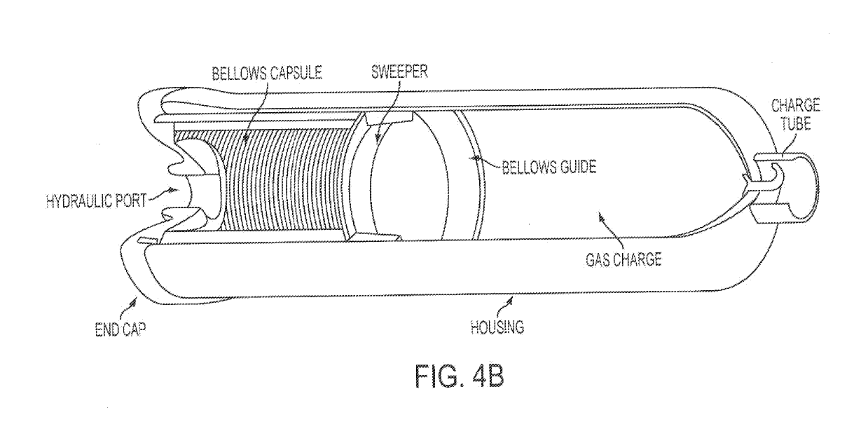

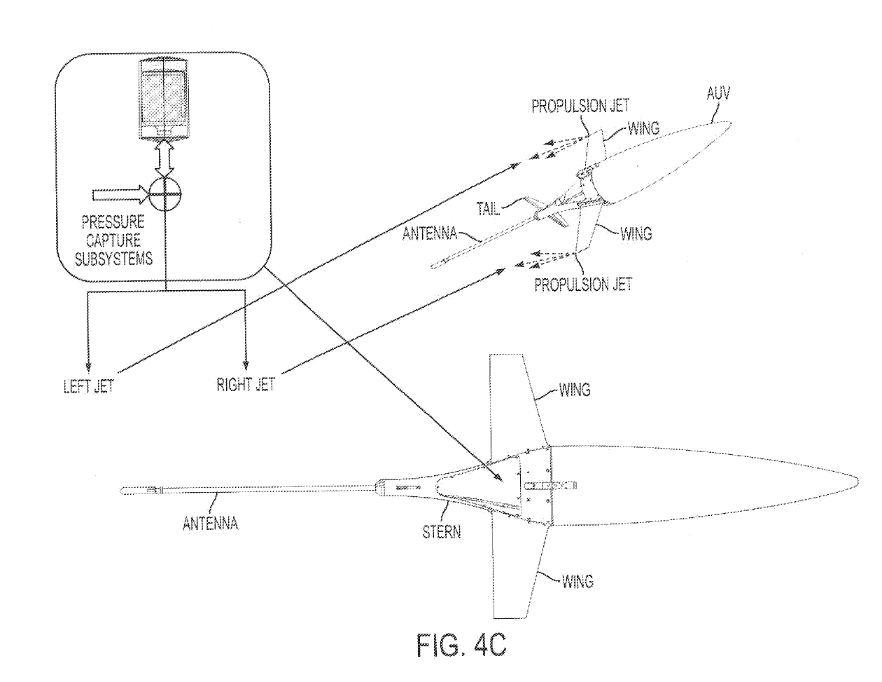

FIG. 4A is a schematic diagram of an exemplary embodiment of a pressure accumulator vessel in accordance with various embodiments of the present teachings that utilizes a compressible fluid rather than a hydraulic fluid, at the surface (left) and at depth (right). The pressure capture vessel can comprise, for example a lightweight, nearly neutrally buoyant container, such as an aluminum shell that is reinforced with a carbon fiber shell. The pressure accumulator vessel can have two chambers, one for holding a pressurized fluid such as, for example, pressurized seawater allowed to enter the pressure accumulator vessel at depth, and one holding a compressible fluid such as, for example, Nitrogen. The Nitrogen can be compress by seawater entering at depths and then allowed to expand to harvest the stored pressure energy (e.g., by powering one or more propulsion jets as discussed above.

In the illustrated exemplary embodiment, the vessel is initially filled with a compressible gas such as nitrogen. The pressure capture vessel is shown, at left, as it would exist with the valve open to allow fluid into the vessel. As shown on the left, at or near the surface, only a small amount of fluid (e.g., hydraulic fluid) has entered the vessel to displace (compress) the nitrogen stored in a separate compartment. At or near the surface, the net buoyancy of the pressure capture vessel can be, for example, about 791 grams, because it is filled almost entirely with gas. As the vehicle descends, however, the pressure capture vessel fills with fluid, compressing the nitrogen to a degree permitted by the pressure of the ocean water passing through the capture and redirect valve manifold. At or near a depth of, for example about 1000 meters, the net buoyancy of the pressure capture vessel can be, for example, about −285 grams, because it is filled mostly with fluid (at right).

Several commercial devices can serve as feasible pressure capture vessels and provide a strong, lightweight container having a nearly neutral buoyancy, for example an aluminum shell reinforced with a carbon fiber shell. Such a pressure capture vessel can weigh, for example, about 1 kilogram and can reliably contain up to about 8000 psi. An exemplary implementation of a pressure capture vessel capable of reliably storing up to 8000 psi at temperature ranges of from about 65° F. to about 275° F. includes a Senior Aerospace Metal Bellows as illustrated in FIG. 4B. The Senior Aerospace Metal Bellows can have sizes ranging from about 0.375″ OD to 18.00″ OD and comprise a housing, a bellows capsule, a hydraulic port, a sweeper, a bellows guide, a gas charge tube, and a gas charge.

The deep water pressure capture system discussed hereinabove can convert deep water ambient pressure to useful energy in deep diving underwater vehicles, for example vehicles that dive to depth of anywhere from 1000 meters to 6000 meters. At such depths, ambient pressures of thousands of psi are experienced. For example, an ambient pressure of 1400 psi is typical at about 1000 meters of ocean depth. Energy from deep water ambient pressure can be harvested regardless of water temperature, making such harvesting reliable and possible in all deep water dives.

In an exemplary implementation, a valve to the pressure capture vessel can be opened at the surface and remain open until an apogee stage is reached (i.e., until about when the vehicle reaches the bottom or a maximum dive depth). The valve for to the pressure capture vessel can then be closed and the harvested pressure can be used as needed as or when the vehicle surfaces.

Using a pressure capture vessel that can safely receive and store pressurized fluid of 1400 psi or greater, the energy content of the differential pressure (i.e., the difference between surface ambient pressure and ambient pressure at greater depths) can be captured. The present teachings contemplate a number of uses for captured pressure. For example, captured pressure can be used to power controlled jets that can propel and direct the autonomous underwater vehicle as shown in FIG. 4C, and/or can be used to drive a pressure-driven mechanism, as described below in more detail. In addition or alternatively, electrical power can be generated from captured pressure, for example upon nearing the surface and as described below in more detail, and can be used for functions such as communications and computing. In accordance with certain underwater vehicle embodiments utilizing rechargeable batteries, captured energy can be converted to electrical power and used to recharge the batteries.

FIG. 4C illustrates an embodiment of the present teachings wherein captured pressure is used to propel an autonomous underwater vehicle. In this exemplary embodiment, the propulsion jets are located at distal ends of oppositely-extending wings of the autonomous underwater vehicle. Locating the propulsion jets at distal ends of the wings, as illustrated, can facilitate use of the propulsion jets for steering. As one skilled in the art would understand, the greater the distance from the longitudinal axis of the autonomous underwater vehicle to the location of the propulsion jet, the greater the ability of the propulsion jet to turn the autonomous underwater vehicle. In the illustrated embodiment, the pressure capture vessel can be located in the stern of the autonomous underwater vehicle, between the left and right propulsion jets. Because the pressure capture vessel is located in the stern of the underwater vehicle, which is ideally raised upon surfacing to allow the antenna to clear the surface for data communication, the added weight of the pressure capture vessel means that the autonomous underwater vehicle may require more energy to properly surface. The pressure capture vessel should generate more energy than is required to compensate for its additional weight.

One skilled in the art will understand that deep water pressure capture can be used in systems other than autonomous underwater vehicles, for example in a variety of floating devices that ascend and descend.

As set forth above, various embodiments of the present teachings comprise a control system for an autonomous underwater vehicle, the control system comprising a control computer, sensors to determine depth, heading angles, and rate of descent, and a buoyancy system for changing the apparent displacement or mass of the underwater vehicle using fluid displacement mechanisms to move fluid between an internal reservoir and an external bladder.

Certain embodiments of the present teachings provide an algorithm for determining the appropriate fluid displacement mechanism to use to achieve a desired change in buoyancy to maintain ascent or descent at a specified velocity through a specific range of depths. The fluid displacement mechanisms can comprise a hydraulic system configured with multiple pumping stages or alternate gearing ratios that can efficiently transfer work from one stage to another without significant impairment of a selected stage, and can work in concert or separately to produce changes in buoyancy with respect to the ambient pressure in effect at the time of execution of buoyancy change.

The present teachings provide a configuration of controls, sensors, and fluid displacement mechanisms that can include motors, pistons, or similar mechanisms that enable a change of buoyancy of the autonomous underwater vehicle in accordance with its environment, to minimize its expenditure of stored energy. An advanced method uses a continuously variable transmission to effectively obtain the benefits of a large number of physically separate stages by employing a single stage having continuously changeable torque, flow rate, and pressure outputs.

The present teachings also comprise a control algorithm that can store a desired path of the autonomous underwater vehicle including a depth profile and bathymetric information about the intended path of travel of the vehicle, such that appropriate buoyancy control actions can be programmed to use the most efficient employment of fluid displacement mechanisms to minimize utilization of onboard stored energy.

As stated above, data transmission and receipt upon surfacing can use about 10 Watts of energy. The present teachings contemplate using the stored pressure to generate about 2 Watts of energy. While the pressure capture vessel can add weight to, and possibly increase the size of, the autonomous underwater vehicle, thus increasing the vehicle's energy usage, the present teachings contemplate selecting a container type that allows harvesting of more energy than it requires.

Stored pressure can be used, for example, upon surfacing for data transmission and receipt, or to drive fluid from the internal reservoir to the external bladder as the autonomous underwater vehicle approaches the surface and surfaces. Pressures stored at depth (e.g., 1400 psi) can easily be used to drive fluid into the external bladder when in shallower waters having an ambient pressure of about, for example, 50 psi.

One skilled in the art will understand that deep water pressure capture can be used in systems other than autonomous underwater vehicles, such as underwater gliders.

Variable Buoyancy (Volume) Mechanism

A variable buoyancy mechanism in accordance with the present teachings can be used, for example, to maintain neutral buoyancy, to increase buoyancy to cause ascent that can create forward movement, and to decrease buoyancy to cause descent that also can create forward movement.

The present teachings also provide a method for operating an underwater vehicle, the method comprising: increasing a relative buoyancy of an underwater vehicle and simultaneously shifting a center of mass of the underwater vehicle to cause at least a portion of the underwater vehicle to rise above a water surface and remain above the water surface for a predetermined amount of time in a predetermined position using a minimal amount of stored energy; and while surfaced, performing tasks that can only be done on the surface, including one or more of RF communications, electro-optical image capture, air temperature measurements, wind measurements, and/or determination of location using GPS or other celestial based location method. The method can also comprise decreasing the relative buoyancy of the unmanned underwater vehicle to neutral or negative buoyancy and shifting a center of mass of the unmanned underwater vehicle to optimally traverse substantially horizontally through the water using propulsion such as propellers or jets (see FIG. 4C), without the energy burden of countering buoyancy effects underwater that would normally induce vertical forces and have to be countered by propulsion energy. Buoyancy can be controlled based on the external pressure and density of water surrounding the vehicle at its current depth throughout a dive cycle or planned path of travel of the vehicle, such that a displacement of the vehicle body is substantially equal to the weight of the vehicle as determined by the density of the water in which the vehicle is traveling. Density of the water can, for example, be determined by a pressure sensor on an exterior surface of the vehicle, the pressure sensor acting as a signal input to an algorithm controlling the buoyancy mechanism.

Certain embodiments of the present teachings also provide a hybrid unmanned underwater vehicle comprising an onboard controller, a buoyancy system, wings, and propulsion thrusters, the vehicle being able to optimize its expenditure of energy using available combined hybrid UUV modes to minimize propulsion energy for tasks such as staying on the surface, gliding at slow speeds using negative and positive buoyancy changes and wings for lift, and utilizing traditional propulsion thrusters when needed. Control commands executed autonomously on an onboard controller can reduce a buoyancy of the vehicle and shift a center of mass of the vehicle in accordance with a programmed itinerary of maneuvers such that the vehicle can efficiently travel horizontally in a neutrally buoyant state. One of the forward nose of the vehicle and the tail of the vehicle can comprise an antenna, the antenna rising above the surface of the water when the vehicle surfaces for radio communicating data that the vehicle has collected using sensors while submerged, or to determine a geographical location of the vehicle.

A hybrid unmanned underwater vehicle in accordance with the present teachings can also comprise one or more of an electro-optical sensor and a sonar sensor located on one of the nose and the tail of the vehicle and configured to be used for above-the-surface reconnaissance when the vehicle is surfaced and for below-the-surface reconnaissance, surveying, mapping, or imaging using acoustic energy, and passive acoustic listening sensors, acoustic digital data recording, acoustic data analysis and classification or typing, acoustic compression or other acoustic signal processing. The acoustic signal processing benefits from an ability of the vehicle to move to commanded locations, hold position, or change position either based on the onboard analysis of acoustic signals or based on commands from a remote controller that is analyzing acoustic data gathered by said UUV and transferred to the remote site for analysis, both machine and human.

Certain embodiments of the present teachings provide an unmanned underwater vehicle configured to perform functions traditionally supported by sonobuoys and to change or hold its position using a propulsion system, the unmanned underwater vehicle comprising a closed-loop onboard controller configured to control the heading and speed of the propulsion system to move the vehicle to commanded or stored locations.

Certain embodiments of the present teachings provide an underwater vehicle comprising an expandable cylindrical body configured to change a buoyancy and a center of gravity of the vehicle, the expandable cylindrical body being capable of withstanding a predetermined range of external hydrodynamic pressures of surrounding water, and being capable of changing a center of mass of the vehicle and a buoyancy of the vehicle by changing a displaced volume of water or apparent internal density of the vehicle, thereby controlling buoyancy and the center of mass of the vehicle. In various embodiments, the expandable cylindrical body can comprise guidance devices to maintain a co-axial direction of expansion of the expandable cylindrical body. A length of the expandable cylindrical body can be shortened for or lengthened by use of electro-mechanical force, such as servo motors or hydraulic cylinders. The expandable cylindrical body comprises a dual sleeve and cylinder design configured to withstand a predetermined amount of hydrostatic pressure and to be filled with a fluid such as a non-compressible fluid, the dual sleeve and cylinder design supporting an external wall of the expanding section while increasing displaced volume and mass by virtue of its hollow center.

Various embodiments of the present teachings provide an unmanned underwater vehicle comprising a variable buoyancy mechanism that is configured to adjust a center of mass of the vehicle and a buoyancy of the vehicle, the variable buoyancy mechanism comprising a miniature hydraulic pump to expand either internal or external bladders, the internal or external bladders being offset from a nominal center of mass of the vehicle.

The present teachings provide an unmanned underwater vehicle having a chamber located at an end of the vehicle, a liquid content of the chamber being adjusted with a pumping mechanism of sufficient force to displace fluid from the external environment to the chamber and displace fluid from the chamber back to the external environment, thereby adjusting a total density of the vehicle and simultaneously shifting a center of mass of the vehicle toward an end of the vehicle containing an internal cavity into which fluid is pumped.

Embodiments of an unmanned underwater vehicle in accordance with the present teachings can comprise an expandable body with a propulsion section, wherein a portion of the expandable body, such as the propulsion section, can be drawn into the body to decrease the vehicle's apparent displacement volume, and can be withdrawn from the body to increase the vehicle's apparent displacement. The propulsion section can, for example, be mounted on a flexible bladder at either end of the body.

The unmanned underwater vehicle can comprise one or more wings or other hydrodynamic structures to produce a forward gliding motion as the vehicle descends or ascends as result of changing buoyancy by changing apparent displacement of the underwater vehicle. The wings or other hydrodynamic structures can be initially collapsed into the body so that the vehicle can be launched with a standard launcher for air deployment. The vehicle can deploy the wings after launch and use the deployed wings to move along underwater trajectories at predetermined target angles of descent or ascent produced by adjusting a center of mass and a buoyancy of the vehicle.

Various embodiments of the unmanned underwater vehicle can also comprise a low hydrodynamic drag propulsion system to supplement propulsion provided by buoyancy changes, so that the vehicle can operate at speeds sufficient to overcome currents or to move to a commanded target location. The low hydrodynamic drag propulsion system can comprises, for example, one of vectored thrust propulsion and collapsible propellers of a type that minimize hydrodynamic drag when not in use.

Certain embodiments of the present teachings provide a method for facilitating communications between an unmanned underwater vehicle and a remote control site, the method comprising: expanding a body of the vehicle to establish and maintain positive buoyancy for the vehicle; shifting a center of mass of the vehicle so that a nose or a tail of a cylindrical body of the vehicle is held above a surface of the water without the addition of electro-motive force; and remaining in the shifted and positively buoyant position of the vehicle so that radio communications, above-the-water electro-optics, and other subsystems needing to be above the surface to operate efficiently, can perform intended tasks. The method can additionally comprise controlling expansion and contraction of the vehicle body to cause the vehicle to have a desired overall neutral, positive, or negative buoyancy as may best support it's mode of operation, the mode of operation comprising one of loitering, hovering, moving horizontally, descending, or ascending.

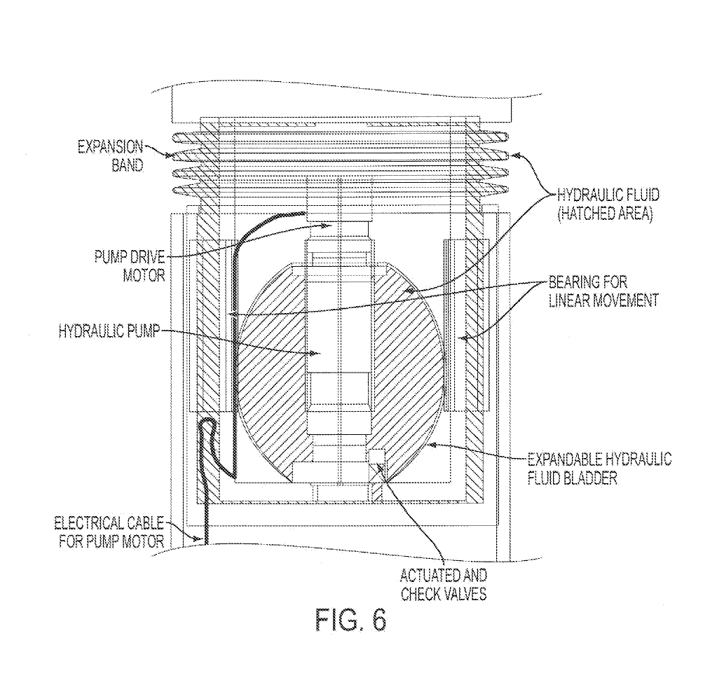

FIGS. 5A and 5B illustrate a portion of an outer shell/body of an exemplary embodiment of an unmanned underwater vehicle (UUV), showing an embodiment of the present teachings wherein an accordion-like portion can expand and contract to change the apparent displacement of the UUV body and thus its buoyancy. As shown, the length of the UUV body can change by an amount ΔL between a variable buoyancy mechanism compressed state (FIG. 1A) and a variable buoyancy mechanism expanded state (FIG. 1B). An accordion-like portion of the UUV body expands and contracts, as shown, to adjust the UUV body length to attain a desired level of buoyancy (i.e., apparent displacement). The body need not always expand and contract by the illustrated amount ΔL, but rather can expand and contract by an amount within a range of zero to ΔL depending on the desired buoyancy change. One skilled in the art will understand that increasing the body length increases the vehicle's apparent displacement and thus its buoyancy. A hydraulic body expansion mechanism is shown within the UUV and is explained in more detail with respect to FIG. 6.

FIG. 6 illustrates an exemplary embodiment of a hydraulic mechanism for length expansion and contraction of the UUV body, with the body in a contracted state. The accordion-like expansion band is shown and can comprise, for example, stainless steel or another suitably strong material or combination of materials. A pump drive motor is shown, which drives the illustrated hydraulic pump to cause fluid to expand or contract the UUV body, and an electrical cable providing power to the motor (e.g., from an on-board battery). The hydraulic pump can send fluid into an expandable hydraulic fluid bladder that comprises, for example, rubber or another suitably strong and flexible material. Actuators and check valves are shown, which control fluid movement. In the illustrated embodiment, hydraulic fluid is stored in the expandable hydraulic fluid bladder when the UUV body is in a contracted state, and is pumped from the expandable hydraulic fluid bladder though the check valve(s) to expand the UUV body. Bearings can be employed to reduce friction during expansion.

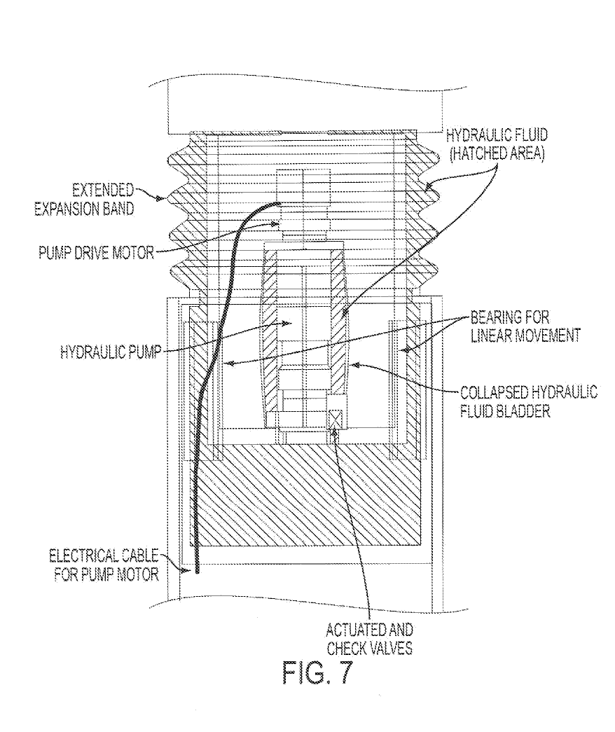

FIG. 7 illustrates the embodiment of FIG. 6, with the UUV body in an expanded state. The hydraulic pump has pumped a substantial portion of the fluid in the centrally-located hydraulic fluid bladder through the check valve(s) and expanded the UUV body. The expansion band is shown in an extended state.

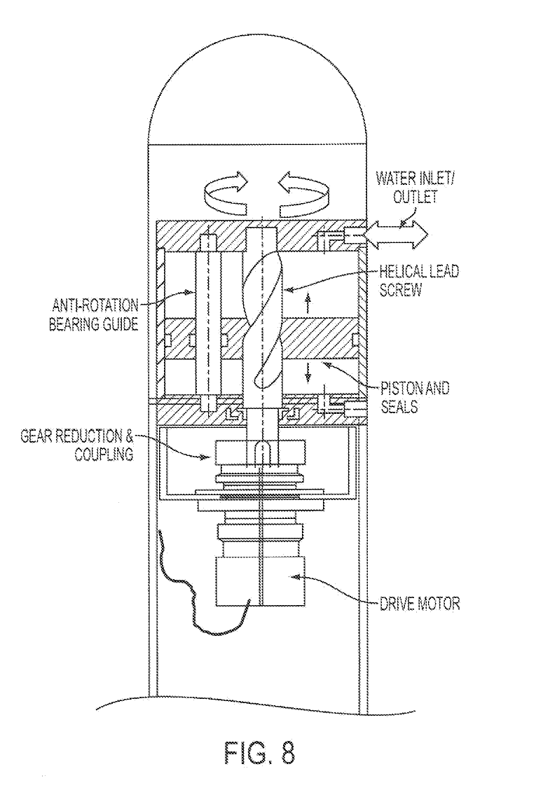

FIG. 8 illustrates another exemplary embodiment of a mechanism for buoyancy and center of mass change of a UUV shell/body. As shown, this embodiment includes a helical lead screw to move a sealed piston toward the nose and the tail of the UUV body. Rotation of the helical lead screw in a clockwise direction and a counter clockwise direction can move the sealed piston toward the nose and toward the tail, respectively. An anti-rotation bearing guide can be utilized to make sure the nose and the tail of the UUV body remain in correct relative positions as the helical lead screw rotates to extend and compress the UUV body. A drive motor for the helical screw is also shown.

The illustrated water inlet/outlet allows the piston to pull water into a chamber of the UUV housing, and push water out of the chamber, which one skilled in the art will understand changes both a center of mass of the UUV body and a buoyancy of the UUV body. For example, pulling water into the illustrated chamber of the UUV housing (the chamber being located between the sealed piston and the nose of the UUV body) can move the center of mass of the UUV toward the nose of the UUV because mass will be added at a location closer to the nose than the existing center of mass. In addition, adding water to the UUV body will decrease its buoyancy for a given displacement (body size). One skilled in the art will understand that a decrease in buoyancy caused by the ingress of water can be offset by an increase in buoyancy caused by expansion (displacement) of the UUV body as described above. Thus, it may be possible to maintain a given buoyancy while pulling water into the UUV body to change its center of mass.

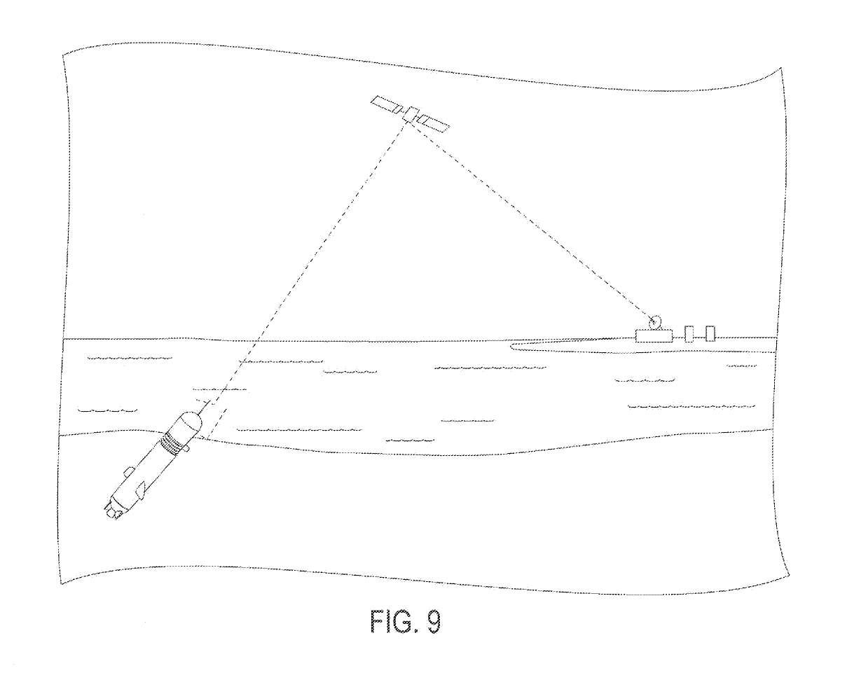

FIG. 9 schematically illustrates a UUV in a surfaced or loitering position, where it can gather information regarding its environment and/or exchange data with a remote site. The UUV surfaces so that its antenna extends above a surface of the water long enough to do one or more of transmit data to a remote site (e.g., a land- or ship-based site), and receive data from a remote control site (e.g., via a satellite link). The satellite data link may include wide geographical coverage.

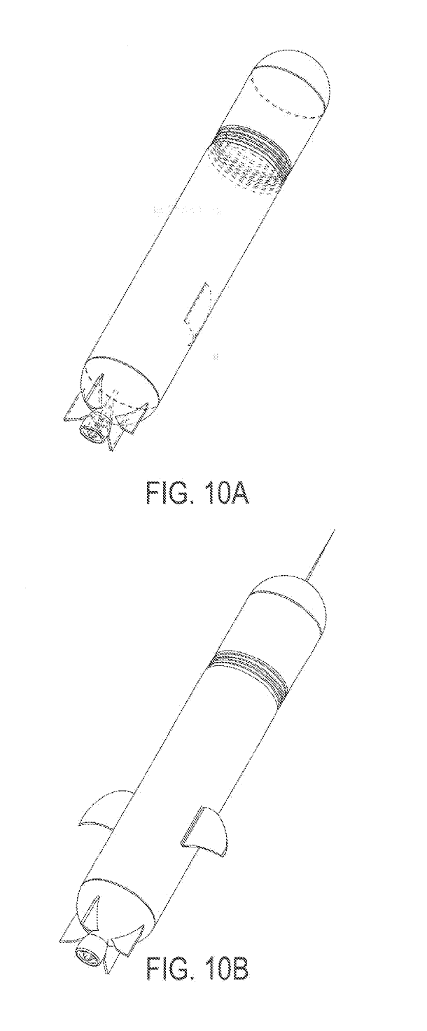

FIG. 10A is a perspective view of an embodiment of a UUV having wings that can be stowed and deployed, with the wings in a stowed position. FIG. 10B is a perspective view of the embodiment of FIG. 10A, with the wings in a deployed position. The wings can be held in a stowed position when the UUV is stored, launched (for example, via an air launch mechanism such as a sonobuoy launch tube for A-sized vehicles), or when gliding is not desirable during the UUV's mission. The wings can be deployed when gliding is desirable. The wings can enable low energy consumption gliding-based propulsion. One skilled in the art will understand that the wings allow the UUV to move laterally as it ascends and descends with changing buoyancy.

FIG. 11 is a perspective view of an exemplary embodiment of a UUV in an ascent attitude, the illustrated UUV being air deployable. An antenna, a buoyancy changing mechanism (in this embodiment, an accordion type expansion area), wings, and a propulsion system are shown. In the illustrated embodiment, the propulsion system is a vectored thruster providing auxiliary or primary propulsion and heading control for the UUV. The illustrated propulsion system is a low drag-type propulsion system.

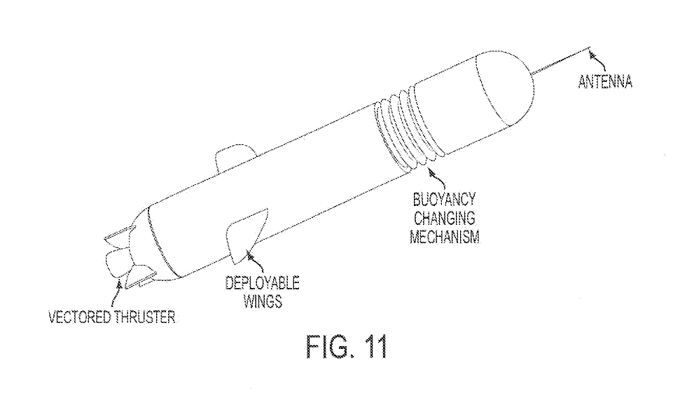

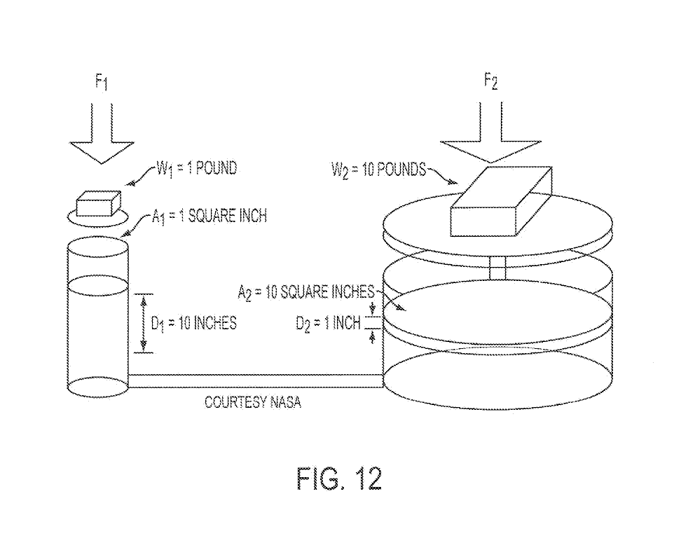

FIG. 12 illustrates a basic principle of hydraulics that can be utilized in a UUV in accordance with the present teachings. The illustrated principle of hydraulics shows that a small force applied against a small piston exerts pressures large enough to offset a large environmental pressure which can be exerted by water on the external skin of a UUV. On the left side of FIG. 12, a one-pound force F₁ applied against a surface area of one square inch can cause a 10 inch movement against a given pressure. On the right side of FIG. 12, a ten-pound force F₁ applied against a surface area of ten square inches can cause only a 1 inch movement against the same given pressure. Thus, a small force on a smaller piston can exert pressures large enough to offset the environmental pressures exerted by water on the larger surface area of the external skin of the vehicle. In an accordion embodiment as shown in FIGS. 5A and 5B, the hydraulic pump can deliver a small volume of fluid to a large surface area to deliver a net displacement force to expand the accordion in the presence of high external hydraulic pressures in deep waters.

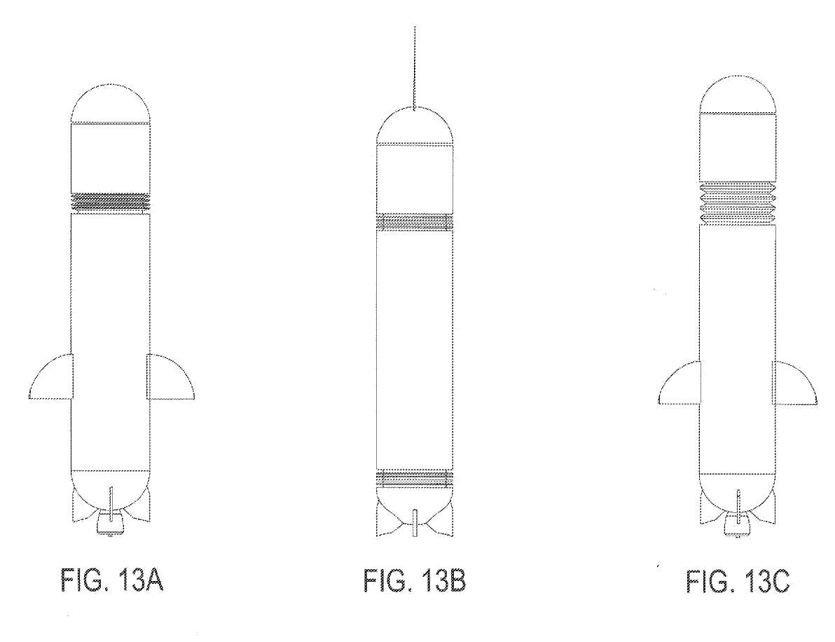

FIG. 13A illustrates a side view of an embodiment of a UUV having deployed wings and with an accordion-like body portion in a contracted position, with a vectored thruster but without an antenna. FIG. 13B illustrates a side view of an embodiment of a UUV having an antenna at its nose, wings in a stowed position, and an accordion-like body portion in a contracted position, having an antenna but not a vectored thruster. FIG. 13C illustrates a side view of the embodiment of FIG. 13A, having deployed wings and with the accordion-like body portion in an expanded position.

A hybrid unmanned underwater vehicle (UUV) in accordance with certain embodiments of the present teachings can be air launched, for example with a sonobuoy launcher, for example an “A size” sonobuoy launcher, as shown and described in U.S. Pat. No. 4,026,188.

Certain embodiments of the present teachings contemplate a combination of one or more of the above design principals in a hybrid UUV, making the UUV able to optimize its expenditure of energy using the available operation modes, such that it can minimize propulsion energy for tasks such as staying on the surface, gliding at slow speeds using negative and positive buoyancy changes and wings for lift, or when demanded be efficient at high speed propulsion using traditional propulsion thrusters.

A variable buoyancy engine and/or an expandable hull can achieve loitering when there is little to no current. However, if the current is too great, the vehicle must employ a station keeping behavior. To “station keep,” an unmanned underwater vehicle can employ a variable buoyancy engine as described above and/or an expandable hull as described above, and additionally employ stored energy to create propulsion power to maintain its position. Deployable wings need not be deployed for station keeping.

For track and trail operations of an unmanned underwater vehicle, stored energy can be utilized to create propulsion power to maintain its position, preferably while neutral buoyancy is maintained to minimize propulsion energy expenditure. Track and trail can also employ loitering and station keeping behaviors when necessary. For sprinting, stored energy can be utilized to create propulsion power to maintain the underwater vehicle's position, preferably while neutral buoyancy is maintained to minimize propulsion energy expenditure.

In various embodiments of the present teachings, a hybrid UUV can station keep using, for example, a GPS connection to self-located and a propulsion unit such as a vector thruster. At the surface or close thereto, the U UV reads its position via GPS and uses a propulsion unit to maintain its position. Station keeping can, however, also occur below the surface, as can loitering. Although loitering and station keeping are at times used interchangeably, loitering can be defined as maintaining an intended position passively (e.g., without expending propulsion energy), whereas station keeping typical employs at least some propulsion to actively maintain an intended position. Sonobuoys, for example, typically cannot station keep because they cannot actively maintain an intended position. To station keep, a hybrid UUV can use a vectored thruster on the surface or move below the surface and, in a horizontal position, circle around the intended position. Moving below the surface can be more energy efficient in areas with greater currents. Moving below the surface can be accomplished by shifting the hybrid UUVs center of mass (e.g., via an internal weight shift as described above) and its apparent displacement or center of buoyancy (e.g., via adjusting an expandable body or adjusting external bladder contents as described above).

### Large Displacement Unmanned Underwater Vehicle

LDUUVs can be difficult to efficiently move through a mission plan, because of their large size, weight, and typical uneven weight distribution. LDUUVs can have a wide variety of payloads that may not allow ideal weight distribution in the vehicle to keep the longitudinal axis of the vehicle naturally in line with a desired direction of travel. For example, more weight on one side of the vehicle or toward a front of the vehicle can cause a trim error of the vehicle. In addition, if the vehicle is not maintained with neutral buoyancy, it can experience ballast errors. In accordance with various embodiments of the present teachings, multiple buoyancy devices (also referred to herein as buoyancy engines) can be used in a large displacement unmanned underwater vehicle (“LDUUV”) to compensate for any uneven distribution of weight in the vehicle. Buoyancy engines in accordance with the present teachings can be adjusted to compensate for uneven weight distribution and achieve neutral buoyancy of a LDUUV to minimize ballast and trim errors in a LDUUV.

The present teachings also contemplate a large displacement unmanned underwater vehicle (LDUUV) (e.g., having a weight of, for example, about 420 lbs) capable of performing long-duration operations, for example in excess of thirty days or in excess of seventy days, rather than the approximate 10-hour duration of existing LDUUVs. The present teachings contemplate increasing endurance of the LDUUV via power reduction technology for the core systems. The LDUUV should additionally be able to perform a variety of scenarios including one or more of station keeping, slow speed transit, and speed bursts.

The propulsion system is the primary power consumer during a LDUUV mission. The present teachings contemplate actively controlling vehicle buoyancy to reduce ballast and trim errors and thereby significantly reduce propulsion power requirements. Without active buoyancy control, a LDUUV can operate with significant ballast and trim errors for some or all of a mission, due to uneven weight distribution and changes in temperature, salinity, and depth of its environment. Ballast and trim errors increase vehicle drag while the vehicle is in transit, and the minimum water speed at which an underwater vehicle can maintain depth. Minimum water speed at which an underwater vehicle can maintain depth increases with buoyancy errors, because the vehicle needs to operate pitched up (or down) with control planes deflected to compensate for buoyancy errors, and the resulting ballast and trim errors increase vehicle drag. As the vehicle drops below a minimum speed, the control planes can no longer generate the force required to compensate for the ballast and trim errors, and the vehicle will begin to drift up or down in the water column.

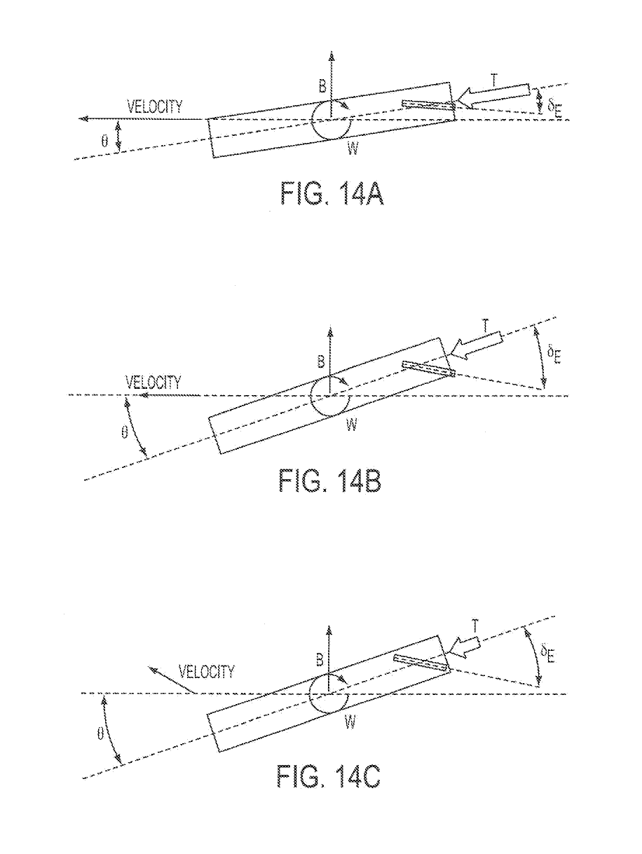

This principal is illustrated in FIGS. 14A-14C, which show a vehicle attempting to maintain level flight at three speeds while positively buoyant. The vehicle must maintain positive elevator deflection (elevator deflection is caused by control fins at a rear of the vehicle, which make the vehicle go up and down with powered propulsion) to keep the vehicle nose pitched down to compensate for a positive buoyancy force. Any pitch or elevation deviation from zero will result in increased vehicle drag and therefore increased propulsion effort to maintain a given speed.

In FIG. 14A, the vehicle speed it at a maximum. In FIG. 14B, the desired speed decreases and the fin deflection and required pitch angle to maintain level flight both increase, while the force generated by the fins to counteract the hydrostatic wrench force (causing by the LDUUV's non-neutral buoyancy) is decreased. For the desired vehicle speed in FIG. 14C, which is less than the desired speed of FIG. 14B, the vehicle has dropped below a minimum speed for its ballast condition, and is no longer able to maintain level flight. The vehicle therefore begins to drift upward due to its positive buoyancy because the vehicle's speed cannot counteract its positive buoyancy.

Various embodiments of the present teachings contemplate realizing a reduction in LDUUV propulsion power using a precision variable buoyancy system (VBS). The precision VBS can be configured to control ballast and trim of the LDUUV to reduce required propulsion power that are needed to maintain level flight of the vehicle during both transit and station-keeping operations. The precision VBS can comprise, for example, two or more fore-mounted and aft-mounted variable buoyancy engines (VBEs) capable of independently changing an apparent displacement of the LDUUV. The precision VBS can also comprise a predictive displacement control algorithm that models total vehicle displacement based on estimated or measured environmental conditions. In accordance with certain embodiments of the present teachings employed in certain missions, net buoyancy can be decreased, for example, from about 1% to about 0.1% of vehicle displacement through the use of a precision VBS, which can yield substantial energy savings during a mission. In an exemplary embodiment, the present teachings contemplate a 5% reduction in total mission propulsion energy by reducing loiter speed from 4.4 knots to 2.1 knots, if the vehicle mission is to hold station between high speed bursts, and a 15% reduction in total mission propulsion energy by reducing vehicle drag power, if the vehicle mission is to transit at 5 knots between high speed bursts.

Temperature and salinity variations in the littorals in which an LDUUV typically operates can cause the local water density to vary by more than three percent, which causes vehicle buoyancy to change in a known manner. In addition, vehicle density with respect to surrounding water (and therefore vehicle buoyancy) can change with depth, depending on the hull compressibility and the presence of entrained air. Hull compressibility and entrained air effect vehicle density (and thus buoyancy) because a compressible hull will compress/shrink as ambient pressure increases and therefore displace less water and become more dense (less buoyant). Entrained air can help prevent even a compressible hull from compressing by exerting a force to counter the ambient pressure. As one skilled in the art would understand, vehicle density changes can change a buoyancy force on the LDUUV and can introduce ballast and trim errors that can decrease energy efficiency.

Significant propulsion energy savings can be realized by using buoyancy control to eliminate environmentally-induced ballast and trim errors (e.g., from non-neutral buoyancy caused by hull compressibility, uneven weight distribution, variations in temperature and salinity), both because the vehicle minimum speed can be reduced as explained above, and because the vehicle drag can be reduced at all vehicle speeds. The present teachings contemplate that the introduction of buoyancy control achieved by a precision VBS as disclosed herein can reduce propulsion power draw by 90% during minimal speed station keeping operations and by 30% during low speed transit operations.

The present teachings also contemplate embodiments that translate power savings obtained during low speed operations into energy savings over the course of a nominal LDUUV mission. It can be desirable for a LDUUV to provide power delivery suitable for both high speed bursts and long periods of lower speed operation. Power delivery requirements can be, for example, consistent with low speeds of between 3 and 5 knots during the majority of an operation, and a burst speed in excess of 10 knots. Given reasonable assumptions for hotel load and vehicle drag, approximately 50 percent of the propulsion energy is expended during low speed operation and 50 percent is expended during high speed bursts. Hotel load is the amount of energy required to run the electrical components (e.g., on-board sensors, buoyancy control system power, and processors) on the vehicle. Therefore, in accordance with certain embodiments of the present teachings, a system in accordance with the present teaching, analyzed with a mathematical model, could reduce low speed power draw, which can translate into a 90% reduction in low speed power, potentially translating to a 45% energy savings. A 30% reduction in low speed power can translate to a 15% energy savings.

LDUUV embodiments in accordance with the present teachings can employ a variable buoyancy system (VBS) comprising at least two variable buoyancy engines (VBEs), each VBE using a pump with, for example, a maximum displacement rate of 7.0 L/min. The VBEs are intended to achieve, for example, a 400 lb net buoyancy adjustment in just under 12.7 minutes. Achieving a 400 lb buoyancy range by varying displacement in seawater requires a 177 L displacement range, and a VBS volume of at least that amount. The volume of the VBS can be reduced by limiting the variable displacement range. The present teachings contemplate that a variable displacement range lower than 400 lbs can employ manual re-ballasting prior to deployment, to ensure that the available displacement range covers the expected operational conditions for the deployment.

In accordance with various embodiments of the present teachings, the at least two VBEs are capable of independently changing their displacements, and the VBS additionally includes a controller implementing a control process configured to estimate buoyancy and command the displacement of each of the VBEs that make up the system. The control process can reside on an embedded processor integrated, for example, into one of the VBE pressure housings. In certain embodiments, the VBS can be a fully modular component, requiring only power and communication with the vehicle controller.

An LDUUV in accordance with the present teachings preferably balances propulsion power gains with the desirability that the VBS have, resistance to biofouling and corrosion, reliability, an acceptable lifetime cost (including installation, maintenance, and disposal remediation), minimized complexity of design, installation, and maintenance, minimized failure modes and system impact of failure modes, scalability, modularity/installation flexibility, and covertness.

The present teaching contemplate utilizing a variety of variable displacement mechanisms including, but not limited to seawater with compressed air, pumped seawater with accumulators, and self-contained hydraulic drives.

A variable displacement mechanism (e.g., a VBE) utilizing seawater with compressed air can comprise, for example, full scale submarine ballast tanks that are filled with sea water and cleared with compressed air. The simplicity and low design cost of seawater/compressed tank systems are accompanied by the need for a separate onboard energy source (the compressed air tanks), susceptibility to biofouling and corrosion within the reservoirs, low precision control of displacement and displacement rate, and unsuitability for covert operations due to gas exhaust. The present teachings also contemplate utilizing a novel hybrid a seawater system in which compressed air is used to equalize pressure on a piston head driven by an electric servo motor, and wherein the air is vented from the piston cylinder as the piston contracts and decreases displacement and air is released from a high pressure cylinder into the piston cylinder as the piston expands to increase displacement. The servo motor can provide high precision displacement control, while the use of compressed air can reduce the power required from the servo motor.

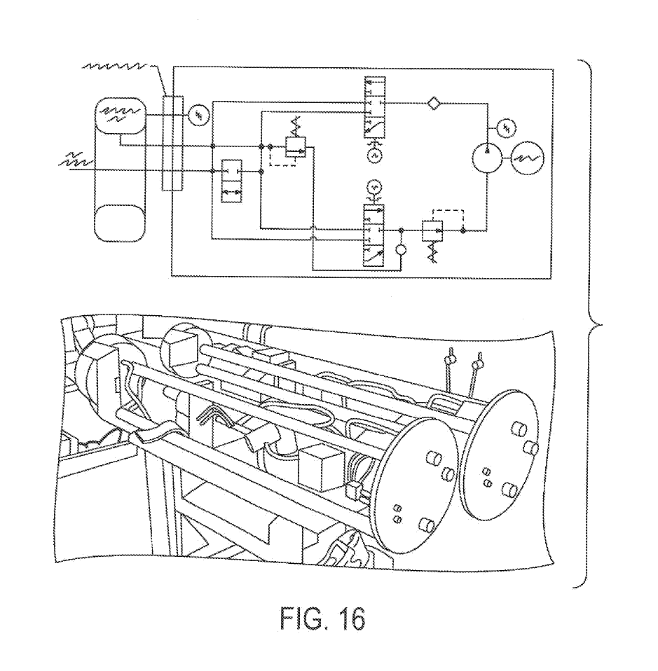

Alternatively or in addition to utilizing variable buoyancy engines, one or more variable displacement mechanisms can utilize pumped seawater with accumulators and can, for example, use pumped seawater to fill and empty accumulators (e.g., rubber inner tubes) within a pressure hull. FIG. 16 illustrates an exemplary embodiment of a variable displacement mechanism. Filling the accumulators increases the mass within the pressure housing, effectively decreasing displacement. Pumping the seawater out of the accumulators decreases mass within the pressure housing effectively increasing displacement. The primary advantage of pumped seawater systems is simplicity, but the exposure of pumping elements and internal chambers to seawater and the need for filtration increases the risk of biofouling, corrosion, and blockages.

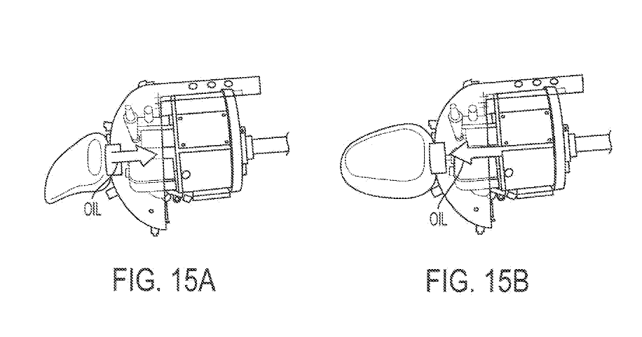

A variable displacement mechanism utilizing a self-contained hydraulic drive can pump oil or another hydraulic fluid between one or more bladders inside of the pressure hull and one or more bladders outside of the pressure hull using, for example, an electric pump. The electric pump can comprise, for example, a motor and a multi-stroke pump to pump efficiently at depth (e.g., up to 1,000 m), and can be used in combination with a boost pump to avoid vapor lock. The present teachings also contemplate using a larger motor with a single stroke pump that is immune to vapor lock, and that trades efficiency for pumping speed to allow for faster buoyancy changes in shallow water (e.g., less than 200 m in depth). FIGS. 15A and 15B illustrate an exemplary variable buoyancy engine with an external bladder that is deflated and inflated, respectively. The illustrated variable buoyancy engine can pump a fixed mass of fluid between an inner reservoir and an external bladder to inflate or deflate the external bladder as discussed in detail hereinabove. Embodiments of the variable buoyancy engines can include the structure set forth above with respect to FIGS. 1 and 2.

Self-contained hydraulics can be more expensive than the use of seawater; however, an advantage of self-contained hydraulic buoyancy engines is that a sealed hydraulic system is more resistant to biofouling and corrosion, because no fluid drive and storage components are internally exposed to seawater. In addition, a self-contained hydraulic buoyancy engine can include very high precision control over displacement, and the flexibility for installation in any flooded cavity because there are no intake/outtake location issues to consider.

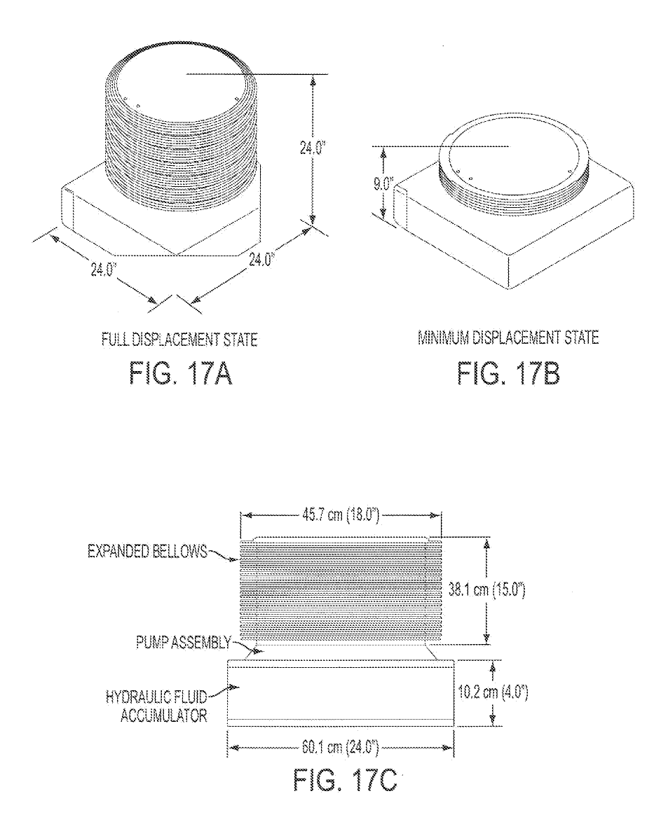

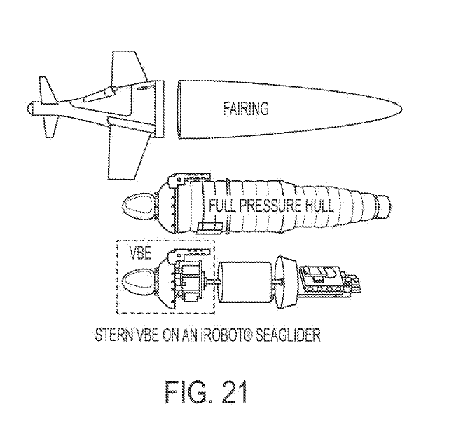

Certain embodiments of the present teachings include a self-contained hydraulic buoyancy engine such as the engine used in the iRobot® Seaglider™ and shown in FIGS. 15A, 15B and 21, which can be modified by using a welded stainless steel bellows as the expansion element instead of a rubber bladder to enable greater mechanical stability for displacement. The variable buoyancy engine can additionally be modified by using low specific gravity (550 kg/m³) synthetic pumping fluid used in the off shore oil industry to reduce minimum system mass. The liquid is substantially incompressible to depths of 3000 m, environmentally inert, and non-toxic. Displacement is varied through the expansion and contraction of the bellows, which is driven by a pump housed within the assembly. In accordance with an exemplary embodiment of a VBE, a bellows assembly can replace certain components of the VBE, including at least the external bladder shown in FIGS. 15A and 15B. An exemplary bellows assembly is illustrated in FIGS. 17A and 17B in an expanded stated and a contracted state, respectively. FIG. 17C provides certain exemplary dimensions of the bellows assembly of FIGS. 17A-C in an expanded state. The illustrated exemplary bellows comprises a hydraulic fluid accumulator, a pump assembly, and a bellows that expands and contracts. Displacement of the underwater vehicle, and thus buoyancy of the underwater vehicle, can be adjusted by expansion and contraction of the bellows, which is driven by a hydraulic pump housed within the assembly.

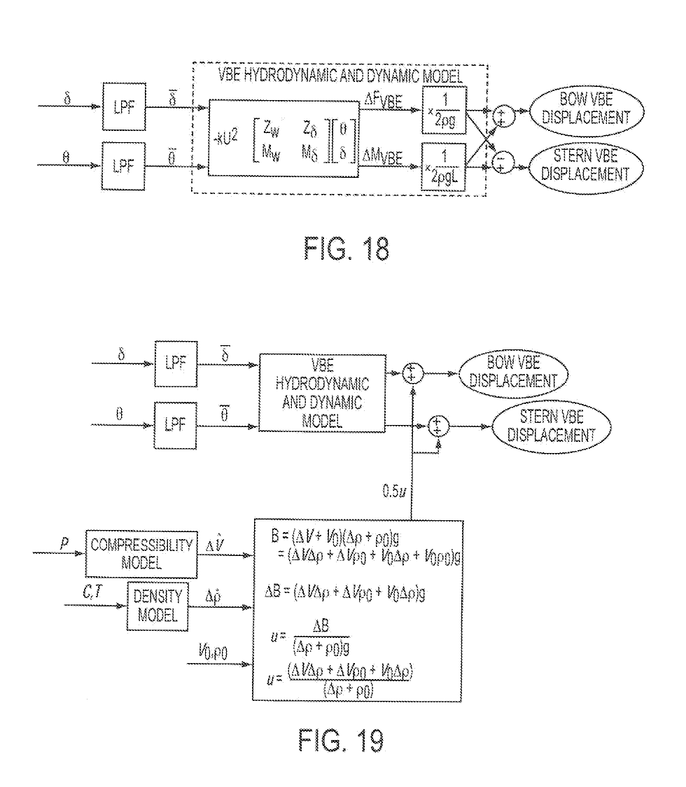

The controller architecture can be designed to reduce latency and improve performance of the LDUUV. Details of exemplary control architectures are illustrated in FIGS. 18-20. FIG. 18 is a control block diagram of an exemplary time-averaged feedback control algorithm to be used for ballast and trim control in an LDUUV having a VBS in accordance with certain embodiments of the present teachings. As shown, pitch δ and elevator θ inputs can each pass through a low pass filter LPF before being used in the VBE hydrodynamic and dynamic model algorithm as time-averaged pitch and elevator inputs. The output of the illustrated algorithm includes displacement values for a VBE located toward a bow of the LDUUV and displacement values for an independent VBE located behind (toward a stern) of the LDUUV.

FIG. 19 is a control block diagram of the exemplary time-averaged feedback control algorithm of FIG. 18 with additional compressibility model and density model inputs creating a model-based feed forward control algorithm that takes advantage of environmental data to reduce latency.

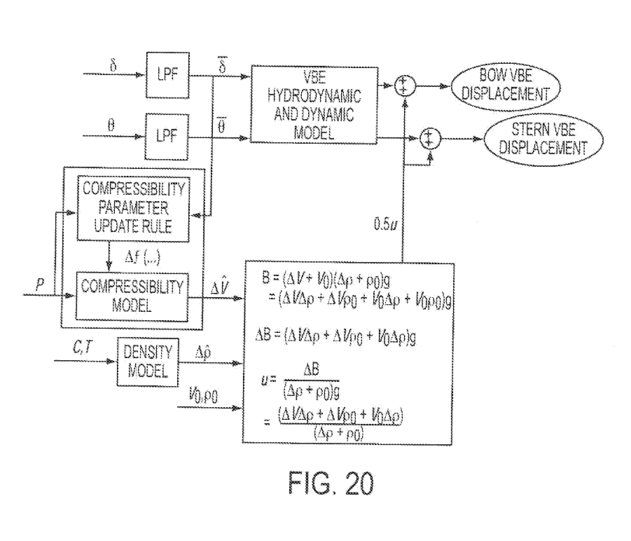

FIG. 20 is a control block diagram of another exemplary adaptive model-based ballast and trim controller. Time averaged pitch angle and elevator deflection are used as inputs to adjust coefficients of a compressibility model and as inputs to the VBE hydrodynamic and dynamic model algorithm. The model can intelligently use a discrepancy between model prediction and actual behavior to refine the model for all operating conditions.

A ballast and trim of the LDUUV will change over the course of long missions, and from mission to mission, as its operating environment and operating configuration change. A major challenge in implementing buoyancy control is that the ballast and trim state of the vehicle cannot be directly measured while the vehicle is undertaking a mission. Previous approaches have used time averaged observations of vehicle pitch and control plane deflection to infer buoyancy state, but this can introduce latency (e.g., a 5-10 minute latency) into the system. Given the continually changing vehicle displacement that can be anticipated as a result of environmental and vehicle changes, the latency of buoyancy state adjustment and correction can be improved using predictive buoyancy adjustments and corrections.

A control algorithm in accordance with various embodiments of the present teachings can augment the slow time-averaged feedback with a feed forward input that attempts to compensate for changes in the calculated instantaneous buoyancy state to reduce latency. Although buoyancy state cannot presently be measured directly, it is possible to create a model of a vehicle's buoyancy state as a function of its environment. In accordance with certain embodiments of the present teachings, the buoyancy state model can consist of two separate sub-models. For example, a density model based on the international Thermodynamics Equations of Seawater 10 (TEOS 10) standard can be used to estimate fluid density from environmental data, using sampled ambient fluid conductivity and temperature as the inputs. In accordance with certain embodiments, a vehicle compressibility model can estimate system volume from the nominal displacement, mass, location, and compressibility of the vehicle, and of each payload component of the vehicle. Combining the two sub-model outputs can produce an estimate of an instantaneous buoyancy state which can be used in the feed forward input to the controller in the manner shown in FIG. 19.

In various embodiments, the compressibility model can be adapted online to increase the precision of vehicle buoyancy estimation, adaption, and correction. The initial parameter values used in the vehicle compressibility model may contain errors resulting from dive-to-dive and deployment-to-deployment changes. Major error sources may include the amount of air entrained at the surface, payload unit-to-unit variations, and in-the-field component changes that are not properly documented. These discrepancies may lead to errors in the model parameters, but will not lead to errors in the model structure itself.

A model referenced adaptive control algorithm as shown in FIG. 20 can be developed that adapts the parameters of the compressibility model until they converge on “true” parameter values, and then tracks those parameters as they change over time. Model-based adaptive control has an established track record for robotics platforms, including UUVs.

Certain embodiments of the present teachings contemplate updating the coefficients of a compressibility model, an improvement over previous implementations of adaptive control that have only updated net buoyancy. Updating the coefficients of the compressibility model allows sampled environmental conditions to be used as inputs to the model update, rather than as a source of potential error. This refinement to the algorithm is particularly appropriate for an LDUUV to improve mission duration and increase energy efficiency as the vehicle and it environment vary during extended mission durations. Previously, the range of environmental conditions to be encountered during short missions could be anticipated, thus limiting the maximum error caused by using a constant value for the vehicle buoyancy. For an LDUUV having increased endurance and longer missions in accordance with the present teachings, it can be less appropriate to use a constant value for vehicle buoyancy because a much wider range of environmental conditions may be encountered.

In accordance with various embodiments of the present teachings, hydrodynamic force and moment models can be developed and applied for LDUUVs having various attributes by integrating analytical models, computational fluid dynamics (CFD) models, and semi-analytical techniques into a unified and consistent model. The model can be nonlinear, geometry-driven, high fidelity, and physics-based. In certain embodiments, the high fidelity hydrodynamic models can be combined with nonlinear six-degree-of-freedom (6-DoF) time-domain equations of motion, and vehicle-specific models of guidance and control hardware and software.

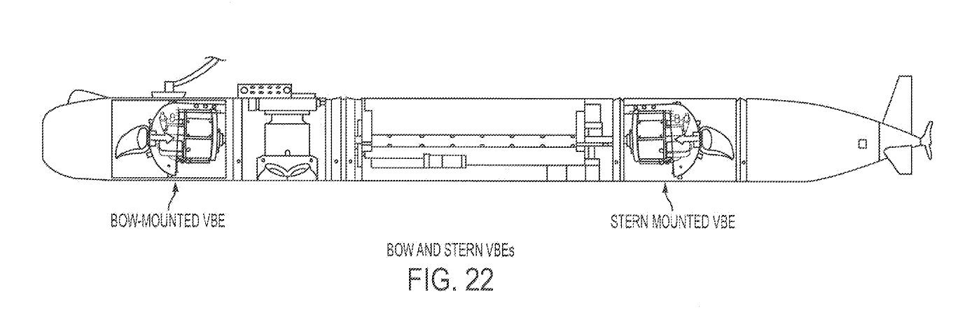

FIG. 22 is an exemplary embodiment of a LDUUV in accordance with the present teachings, illustrating how a VBS in accordance with the present teachings, including a bow VBE and a stern VBE, can be integrated into a LDUUV hull by mounting a bow VBE to an end cap of the LDUUV hull and a stern VBE behind the bow VBE. Fluid can be pumped from an internal volume of the hull, through the end cap, and into a rubber bladder of the bow VBE (or a bellows substituting therefore) in order to change displacement of the LDUUV.

An embedded processor stack can be added to the hull section of the LDUUV for communications, data acquisition, and pump/valve drive logic. In an exemplary embodiment, the Massachusetts Institute of Technology/Naval Undersea Warfare Center (MIT/NUWC) MOOS robotics operating system can be deployed as an interface on embedded OMAP 4 processors under Linux. An electrical interface between the VBEs and both the embedded processor and the vehicle power supply can be accomplished using a known interface board.

A system in accordance with the present teachings can comprise a LDUUV with at least the following subsystems: two displacement mechanisms (e.g., VBEs), a control algorithm, an embedded processor stack, a software framework, a power source and power management, sensors and data acquisition hardware, and communications.

The present teachings contemplate using a hydraulic fluid that is incompressible and has a specific gravity of less than 0.5, for example the low specific gravity (550 kg/m³) synthetic pumping fluid used in the off shore oil industry to reduce minimum system mass. The liquid is substantially incompressible to depths of 3000 m, environmentally inert, and non-toxic. This would allow, for example, the vehicle to displace a greater amount of water than the weight of the hydraulic fluid displacing the water. This effectively allows the hydraulic fluid displaces twice as much water as it's own weight for a given volume of displacement.

Other embodiments of the present teachings will be apparent to those skilled in the art from consideration of the specification and practice of the present teachings disclosed herein. It is intended that the specification and examples be considered as exemplary only, with a true scope and spirit of the present teachings being indicated by the following claims.

What is claimed is:

1. An A-sized unmanned underwater vehicle comprising:
a body housing a controller;
a vector thruster attached to the body, in communication with the controller, and configured to propel the body;
at least one deployable wing structure attached to the body, in communication with the controller, and configured to be deployed to allow the unmanned underwater vehicle to traverse by gliding as the unmanned underwater vehicle ascends and descends;
a center-of-mass shifter located within the body, in communication with the controller, and configured to shift a center-of-mass of the vehicle to allow the unmanned underwater vehicle to pitch up and pitch down; and
one of a multi-stage buoyancy control system within the body and configured to adjust an apparent displacement of the unmanned underwater vehicle and an expandable outer shell configured to adjust an apparent displacement and therefore a buoyancy of the unmanned underwater vehicle.

2. The A-sized unmanned underwater vehicle of claim 1, being capable of loitering to upload data and download data, station keeping, and sprinting.

3. The A-sized unmanned underwater vehicle of claim 1, being capable of increasing mission lifetime by minimize energy expenditure by maintaining neutral buoyancy using the one of the multi-stage buoyancy control system and the expandable outer shell.

4. The A-sized unmanned underwater vehicle of claim 1, wherein the buoyancy of the unmanned underwater vehicle is adjust to remain neutral as a temperature and density of an environment of the unmanned underwater vehicle change.

5. A method for harvesting ambient underwater pressure for use in a remote vehicle having a pressure capture chamber and a capture and re-direct valve, the method comprising:
allowing pressurized ocean water to flow through the capture and re-direct valve and drive fluid into the pressure capture vessel to pressurize the pressure capture vessel by filling the pressure capture vessel; and
using pressure stored in the pressure capture vessel to drive a propulsion jet system.

6. The method of claim 5, wherein the propulsion jet system comprises a left propulsion jet and a right propulsion jet.

7. The method of claim 6, further comprising using the propulsion jet system to provide one or more of steering or a speed boost.

8. A method for harvesting ambient underwater pressure for use in a remote vehicle having a pressure capture vessel and a capture and re-direct valve, the method comprising:
allowing pressurized ocean water to flow through the capture and re-direct valve and drive fluid into the pressure capture vessel to pressurize the pressure capture vessel by filling the pressure capture vessel; and
releasing pressurized fluid from the pressure capture vessel to push fluid through a power generator to convert stored pressurized fluid to electrical power.

9. The method of claim 8, wherein the power generator comprises a gyrator pump and a DC power generator.

10. The method of claim 8, further comprising using the electrical power produced by the generator immediately.

11. The method of claim 10, further comprising using the electrical power for communication.

12. The method of claim 10, further comprising using the electrical power for computing.

13. The method of claim 8, further comprising storing the electrical power in a voltage storage device.

14. The method of claim 13, wherein the voltage storage device comprises a rechargeable battery.

15. A method for harvesting ambient underwater pressure for use in a remote vehicle having a pressure capture chamber and a capture and re-direct valve, the method comprising:
allowing pressurized ocean water to flow through the capture and re-direct valve and drive fluid into the pressure capture vessel to pressurize the pressure capture vessel by filling the pressure capture vessel; and
using pressure stored in the pressure capture vessel to drive fluid from an internal reservoir of the autonomous underwater vehicle to an external bladder of the autonomous underwater vehicle to increase an apparent displacement and a buoyancy of the autonomous underwater vehicle.

16. A system for harvesting ambient underwater pressure for use in a remote vehicle, the system comprising:
a fluid reservoir;
a pressure capture vessel connected to the fluid reservoir; and
a capture and re-direct valve configured to allow pressurized ocean water to flow therethrough and drive a fluid from the fluid reservoir into the pressure capture vessel to pressurize the pressure capture vessel by filling the pressure capture vessel,
wherein pressurized fluid can be released from the pressure capture vessel to perform work for the autonomous underwater vehicle.

17. The system of claim 16, further comprising an internal reservoir and an external bladder, wherein performing work comprises using pressure stored in the pressure capture vessel to drive fluid from the internal reservoir to the external bladder to increase an apparent displacement and a buoyancy of the autonomous underwater vehicle.

18. The system of claim 16, further comprising a power generator, and wherein performing work comprises releasing pressurized fluid from the pressure capture vessel to push fluid through the power generator to convert stored pressure to electrical power.

19. The system of claim 16, further comprising a jet propulsion system and wherein performing work comprises using pressure stored in the pressure capture vessel to drive the propulsion jet system.

20. An unmanned underwater vehicle that is propelled by buoyancy and achieves forward motion using wings for lift, the unmanned underwater vehicle having a size and form factor equivalent to a standardized sonobuoy and being configured for rapid air deployment and long endurance.

21. A method for operating an unmanned underwater vehicle, the method comprising:
increasing a relative buoyancy of an unmanned underwater vehicle under servo control and simultaneously shifting a center of mass of the unmanned underwater vehicle to cause at least a portion of the unmanned under water vehicle to rise above a water surface and remain above the water for a predetermined amount of time in a predetermined position using a minimal amount of stored energy; and
while surfaced, performing tasks that can only be done on the surface, including one or more of RF communications, electro-optical image capture, air temperature measurements, wind measurements, determination of location using GPS or other celestial based location method.

22. The method of claim 21, further comprising decreasing the relative buoyancy of the unmanned underwater vehicle to a neutral or negative buoyancy and shifting a center of mass of the unmanned underwater vehicle to optimally traverse substantially horizontally through the water using propulsion such as propellers or jets, without the energy burden of countering buoyancy effects underwater that would normally induce vertical forces and have to be countered by propulsion energy.

23. The method of claim 22, wherein buoyancy can be controlled based on the external pressure and density of water surrounding the vehicle at a current depth of the vehicle throughout a dive cycle or planned path of travel of the vehicle, such that a displacement of the vehicle body is substantially equal to the weight of the vehicle as determined by the density of the water in which the vehicle is traveling.

24. The method of claim 23, wherein the density of the water is determined by a pressure sensor on an exterior surface of the vehicle, the pressure sensor acting as a signal input to an algorithm controlling the buoyancy mechanism.

25. A hybrid unmanned underwater vehicle comprising an onboard control computer, a buoyancy system, wings, and propulsion thrusters, the vehicle being able to optimize its expenditure of energy using available combined hybrid modes to minimize propulsion energy for tasks such as staying on the surface, gliding at slow speeds using negative and positive buoyancy changes and wings for lift, and efficiently utilizing traditional propulsion thrusters when needed.

26. The hybrid unmanned underwater vehicle of claim 25, wherein control commands executed autonomously on the onboard control computer can reduce a buoyancy of the vehicle and shift a center of gravity of the vehicle in accordance with a programmed itinerary of maneuvers such that the vehicle can efficiently travel horizontally in a neutrally buoyant state.

27. The hybrid unmanned underwater vehicle of claim 26, wherein one of the forward nose of the vehicle and the tail of the vehicle comprises an antenna, the antenna rising above the surface of the water when the vehicle surfaces for radio communicating data that the vehicle has collected using sensors while submerged, or to obtain geographical fix of location of the vehicle.

28. The hybrid unmanned underwater vehicle of claim 27, further comprising one or more of an electro-optical sensor and a sonar sensor located on one of the nose and the tail of the vehicle and configured to be used for above-the-surface reconnaissance when the vehicle is surfaced and for below-the-surface reconnaissance, surveying, mapping, or imaging using acoustic energy.

29. The hybrid unmanned underwater vehicle of claim 28, further comprising passive acoustic listening sensors, acoustic digital data recording, acoustic data analysis and classification or typing, acoustic compression or other acoustic signal processing.

30. The hybrid unmanned underwater vehicle of claim 29, wherein the acoustic signal processing benefits from an ability of the vehicle to move to commanded locations, hold position, or change position either based on the onboard analysis of acoustic signals or based on commands from a remote controller that is analyzing acoustic data gathered by said UUV and transferred to the remote site for analysis, both machine and human.

31. An unmanned underwater vehicle configured to perform functions traditionally supported by sonobuoys and to change or hold its position using a propulsion system, the unmanned underwater vehicle comprising a closed-loop onboard controller configured to control the heading and speed of the propulsion system to move the vehicle to commanded or stored locations.

32. An unmanned underwater vehicle comprising an expandable cylindrical body configured to change a buoyancy and a center of gravity of the vehicle, the expandable cylindrical body being capable of withstanding a predetermined range of external hydrodynamic pressures of surrounding water, and being capable of changing a center of gravity of the vehicle and a buoyancy of the vehicle to change a displaced volume of water or apparent internal density of the vehicle, thereby controlling buoyancy and center of gravity of the vehicle.

33. The unmanned underwater vehicle of claim 32, wherein the expandable cylindrical body comprises guidance devices to maintain a co-axial direction of expansion of the expandable cylindrical body.

34. The unmanned underwater vehicle of claim 32, wherein a length of the expandable cylindrical body can be shortened for or lengthened by use of electro-mechanical force, such as servo motors or hydraulic cylinders.

35. The unmanned underwater vehicle of claim 32, wherein the expandable cylindrical body comprises a dual sleeve and cylinder design configured to withstand a predetermined amount of hydrostatic pressure and filled with non-compressible fluid, the design supporting an external wall of the expanding section while increasing displaced volume and mass by virtue of a hollow center of the body.

36. A hybrid unmanned underwater vehicle comprising an expandable body with a propulsion section, wherein portion of the expandable body, such as the propulsion section, can be compressed to decrease the vehicle's external displacement volume, and can be expanded from the body to increase the vehicle's external displacement.

37. The hybrid unmanned underwater vehicle of claim 36, wherein the propulsion section is mounted on a flexible bladder at either end of the body.

38. The hybrid unmanned underwater vehicle of claim 37, comprising one or more wings or other hydrodynamic structures to produce a forward gliding motion as the vehicle descends or ascends as result of changing buoyancy.

39. The hybrid unmanned underwater vehicle of claim 38, wherein the wings or other hydrodynamic structures are initially collapsed into the body so that the vehicle can be launched with a standard launcher for air deployment.

40. A method for facilitating communications between an unmanned underwater vehicle and a remote control site, the method comprising expanding a body of the vehicle to establish and maintain positive buoyancy for the vehicle;
shifting a center of mass of the vehicle so that a nose or a tail of a cylindrical body of the vehicle is held above a surface of the water without the addition of electro-motive force; and
remaining in the shifted and positively buoyant position of the vehicle so that radio communications, above-the-water electro-optics, and other subsystems needing to be above the surface to operate efficiently, can perform tasks.

41. The method of claim 40, further comprising controlling expansion and contraction of the vehicle body to cause the vehicle to have a desired overall neutral, positive, or negative buoyancy as may best support it's mode of operation, the mode of operation comprising one of hovering, moving horizontally, descending, or ascending.

42. A large displacement unmanned underwater vehicle including one or more sensors, a propulsion system, and a controller for controlling a mission of the vehicle, and comprising:
a variable buoyancy system including a first variable buoyancy engine located toward a bow of the vehicle and a second variable buoyancy engine located toward a stern of the vehicle, the variable buoyancy system being configured to control apparent displacement of the vehicle to actively control vehicle buoyancy to maintain neutral buoyancy and reduce ballast and trim errors to reduce propulsion power requirements.

43. The large displacement unmanned underwater vehicle of claim 42, wherein the vehicle is capable of station keeping, slow speed transit, and speed bursts.

44. The large displacement unmanned underwater vehicle of claim 42, wherein the first variable buoyancy engine is controlled by the controller independently of the second variable buoyancy engine to change an apparent displacement of the vehicle.

45. The large displacement unmanned underwater vehicle of claim 42, wherein the variable buoyancy system is a fully modular component requiring only power and communication with the vehicle controller.

46. The large displacement unmanned underwater vehicle of claim 42, wherein at least one of the first variable buoyancy engine and the second variable buoyancy engine utilize a low specific gravity synthetic pumping fluid that is substantially incompressible to depths of 3000 m, environmentally inert, and non-toxic.

47. The large displacement unmanned underwater vehicle of claim 42, wherein at least one of the first variable buoyancy engine and the second variable buoyancy engine comprises a bellows assembly that expands and contracts to change an apparent displacement of the vehicle.

48. The large displacement unmanned underwater vehicle of claim 42, wherein the controller implements a control process configured to estimate buoyancy and command a displacement of the first variable buoyancy engine and the second variable buoyancy engine.

49. The large displacement unmanned underwater vehicle of claim 48, wherein the control process utilizes a time-averaged feedback control algorithm for ballast and trim control.

50. The large displacement unmanned underwater vehicle of claim 49, wherein the control process utilizes predictive buoyancy adjustments and corrections.
